(19) United States
(12) Patent Application Publication
(10) Pub. No.: US 2020/0341882 A1
(43) Pub. Date: Oct. 29, 2020

(54) SYSTEMS AND METHODS FOR DETERMINING A CREATIVE COLLABORATION INDEX

(71) Applicant: Haworth, Inc., Holland, MI (US)

(72) Inventors: Demian ENTREKIN, Oakland, CA (US); Rupen Chanda, San Francisco, CA (US); Michael William Morris, Foster City, CA (US)

(73) Assignee: Haworth, Inc., Holland, MI (US)

(21) Appl. No.: 16/591,415

(22) Filed: Oct. 2, 2019

Related U.S. Application Data
(60) Provisional application No. 62/839,483, filed on Apr. 26, 2019.

(51) Int. Cl. G06F 11/34; H04L 12/18; G06F 11/30

(52) U.S. Cl. CPC G06F 11/3438; H04L 12/1831; G06F 11/3086; G06F 11/302; G06F 11/3006

(57) ABSTRACT

Systems and techniques are provided for monitoring a collaboration system. The system accumulates a log of entries to identify events in the collaboration workspace. An entry in the log of entries identifies an event and comprises data specifying virtual coordinates of location within the workspace at which an interaction with the workspace is detected, data identifying a type of interaction, a graphical object associated with the interaction, and a time of the interaction. The system assigns classifications to entries in the log according to the data identifying a type of interaction. The system displays a graphical construct as a function of the classifications of the entries in the log of entries.

### PRIORITY APPLICATION

This application claims the benefit of U.S. Provisional Patent Application No. 62/839,483 filed 26 Apr. 2019; which application is incorporated herein by reference.

### BACKGROUND

### Field

The present invention relates to collaboration systems that enable users to participate in collaboration sessions from multiple locations.

### Description of Related Art

Collaboration systems are used in a variety of environments to allow users to contribute and participate in content generation and review. Users of collaboration system can join collaboration sessions from locations around the world. It is important to determine the utilization of collaboration systems. The collaboration systems are complex systems with multiple users participating in the collaboration sessions from one or more locations. The systems can generate a large number of interaction events as users collaborate during meetings. The systems can also receive additional information from other systems used for scheduling and conferencing. The users can use the collaboration systems over a long period of time such as for the duration of a project. During this time, different forms of collaboration sessions can occur for example, planning sessions, design meeting, reviews, etc. The users can work on project deliverables in a meeting environment in which multiple users participate or independently. The large amounts of interaction events data generated by collaboration systems makes it difficult for project managers, seniors executives, teachers, etc., to evaluate the effectiveness of collaboration systems in achievement of their project management or instruction goals.

It is desirable to provide a system that can more effectively and automatically monitor interaction events generated by collaboration systems and determine the level of contributions of users participating in collaboration sessions.

### SUMMARY

A system and method for operating a system are provided for monitoring a collaboration system. Technology is provided to determine the utilization of collaboration systems in which users from one or more locations across the globe can participate and contribute to collaboration sessions. In one aspect, the contributions of the users to the collaboration session can be presented in a graphic user interface including widgets that prompt display of collaboration session workspace with high level of collaboration or replay a portion of the collaboration session in which high level of collaboration occurred.

The system includes a network node including memory storing a log of entries to identify events in the collaboration workspace. An entry in the log of entries identifies an event. The entry in the log of entries comprises data specifying virtual coordinates of location within the workspace at which an interaction with the workspace is detected, data identifying a type of interaction, a graphical object associated with the interaction, and a time of the interaction. The network node further includes logic to assign classifications to entries in the log according to the data identifying a type of interaction and display a graphical construct as a function of the classifications of the entries in the log of entries.

In one embodiment, the classifications are assigned according to relative timing of the interactions with interactions represented by other entries. The classifications can include a plurality of categories, including create events, curate events, review events, present events, and administration events.

In one embodiment, the network node further includes logic to receive metadata associating events in the log with workspace displays at which the interactions identified in the events are detected. In this embodiment, the classifications are assigned according to workspace display.

In one embodiment, the network node further includes logic to receive metadata associating events in the log with users associated with the interactions. In this embodiment, the classifications are assigned according to workspace display. The metadata associating events in the log with users can comprise scheduling information linking the workspace displays and the users. The metadata associating events in the log with users can comprise conferencing information linked to the workspace display and the users. The metadata associating events in the log with users can comprise a number of users participating in the collaboration workspace at the time of the interaction.

The graphical representation can represent the log of entries for an organization according to the time of the interaction and the classifications of the events. The graphical representation can represent the log of entries for a team according to the time of the interaction and the classifications of the events.

In one embodiment, the network node further includes logic to determine a category score using a weighted combination of classifications of events according to the time of interaction. In another embodiment, the network node includes logic to determine a collaboration score using a weighted combination of classifications of events according to the time of interaction. The network node can include logic to assign weights to the categories using the number of users participating in a collaboration workspace.

In one embodiment, the network node further includes logic to receive by a communication link from a client processor controlling an interactive workspace display, messages according to a message protocol identifying events for interactions detected on a part of the workspace being rendered on the interactive workspace display controlled by the client processor. The network node includes logic to add the received messages to the log of entries. The network node includes further includes logic to parse the messages according to the message protocol to produce entries for the log of entries. The message protocol comprises message formats carrying parameters for an application program interface API, the API including parameters and procedures to render parts of the workspace on workspace displays.

Methods and computer program products which can be executed by computer systems are also described herein.

Functions are described herein, including but not limited to accumulating a log of entries to identify interaction events, assigning classifications to entries in the log of entries and displaying graphical construct as a function of the classifications of entries in the log of entries and receiving and processing requests to determine a workspace with high collaboration among participants present complex problems of computer engineering, relating for example to the type of interaction data to be processed, and what processing of the interaction data to perform.

Other aspects and advantages of the present invention can be seen on review of the drawings, the detailed description and the claims, which follow.

### BRIEF DESCRIPTION OF THE DRAWINGS

The invention will be described with respect to specific embodiments thereof, and reference will be made to the drawings, which are not drawn to scale, and in which:

FIGS. 1A and 1B (collectively FIG. 1) illustrate example aspects of a digital display collaboration environment.

FIG. 2 is a flowchart presenting aspects of the server-side logic to process interaction events, classify the interaction events into categories and determine collaboration score.

FIG. 3A, FIG. 3B, FIG. 3C, FIG. 3D and FIG. 3E (collectively FIG. 3) show illustrations of example workspaces.

FIG. 4 presents process steps for determining collaboration scores and displaying graphical constructs.

FIG. 5A presents graphical illustration of collaboration scores for a team and per person over time.

FIG. 5B presents an example visualization of collaboration scores per category at thirty-minute intervals.

FIG. 5C presents a graphical illustration of collaboration scores at five-minute intervals.

FIG. 6A, FIG. 6B, FIG. 6C, FIG. 6D, FIG. 6E and FIG. 6G (collectively FIG. 6) is a simplified diagram of data structures for parts of the workspace data.

FIG. 7 is a simplified functional block diagram of a client-side network node and display.

FIG. 8 is a simplified block diagram of the computer system 110, e.g. a client device computer system (FIG. 1B).

FIG. 9 is a flowchart illustrating aspects of server-side logic when a user joins a collaboration session.

FIG. 10 is a simplified functional block diagram of a client-side network node and display.

FIG. 11 is a flowchart illustrating operation of client-side network node like that of FIG. 10.

### DETAILED DESCRIPTION

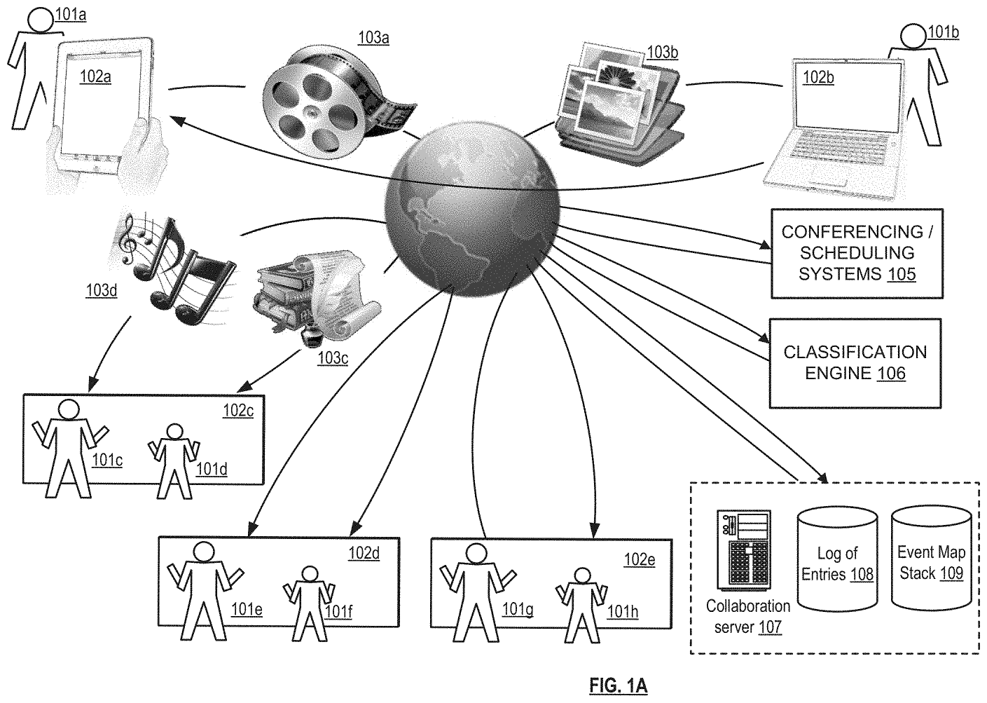

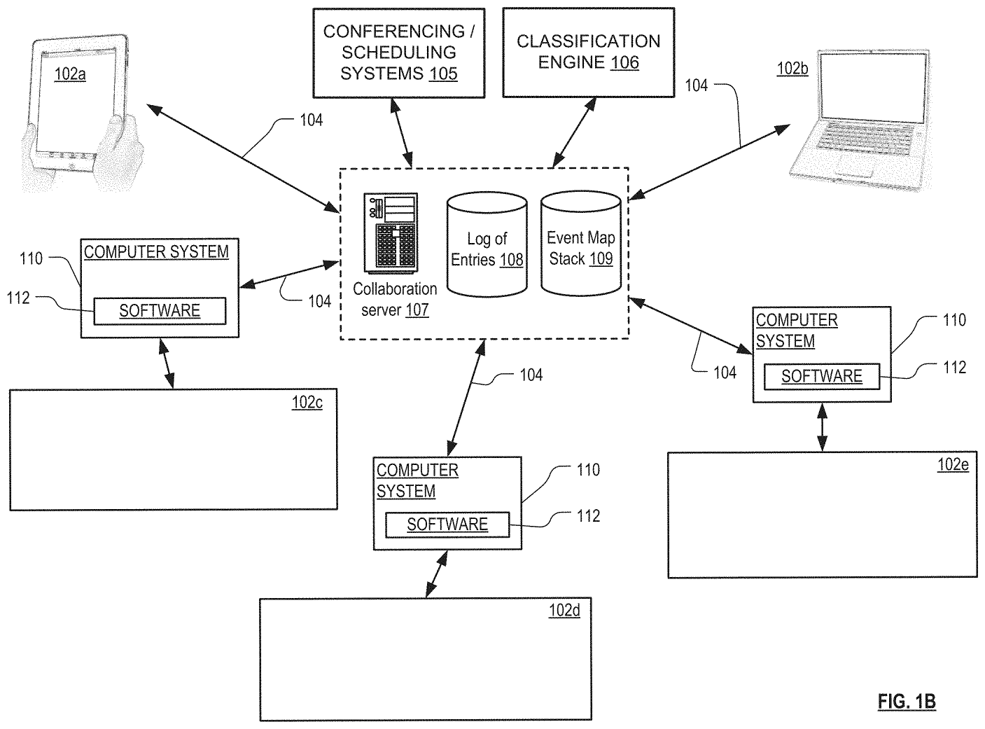

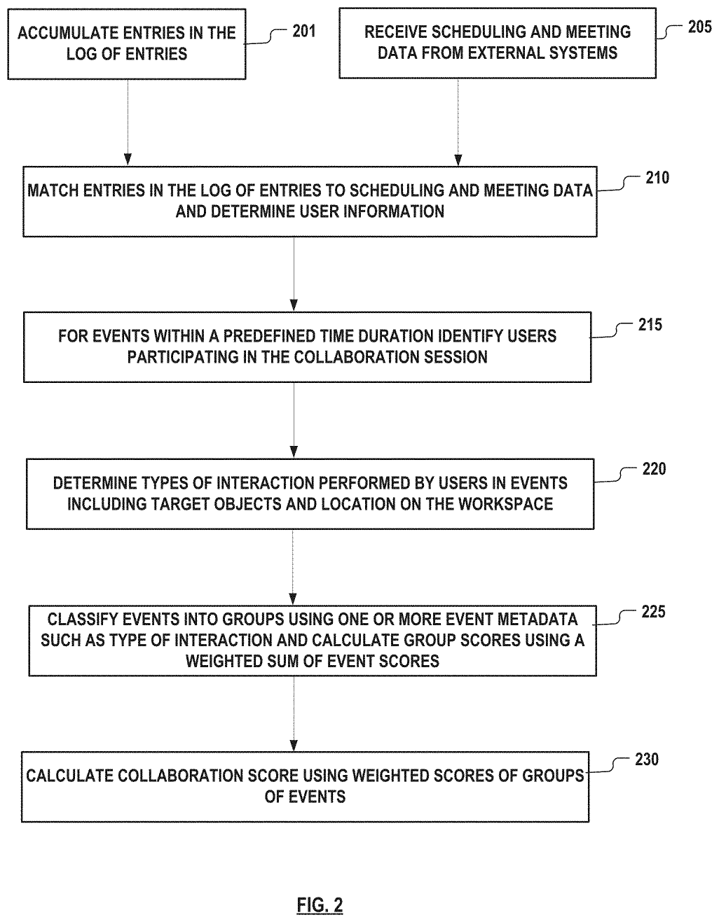

A detailed description of embodiments of the present invention is provided with reference to the FIGS. 1-10.

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

We describe a collaboration environment in which users participate in an interactive collaboration session from locations across the world. A participant can join and participate in the collaboration session using large format digital displays, desktop and laptop computers, or mobile computing devices. Following the description of this example collaboration environment, we address the problem of evaluating utilization of collaboration systems by teams or groups of users. We present details of the technology disclosed to gather and classify data generated during collaboration sessions. We then present description of various elements of the technology disclosed to enable the reader to understand features of these elements. The details of the technology disclosed are illustrated using an example collaboration workspace.

FIG. 1A illustrates example aspects of a digital display collaboration environment. In the example, a plurality of users 101a-h (collectively 101), may desire to collaborate with each other in the creation of complex images, music, video, documents, and/or other media, all generally designated in FIG. 1A as 103a-d (collectively 103). The users in the illustrated example use a variety of devices configured as electronic network nodes, in order to collaborate with each other, for example a tablet 102a, a personal computer (PC) 102b, and many large format displays 102c, 102d, 102e (collectively devices 102). The electronic network nodes can be positioned in locations around the world. In the illustrated example the large format display 102c, which is sometimes referred to herein as a “wall”, accommodates more than one of the users, (e.g. users 101c and 101d, users 101e and 101f, and users 101g and 101h). The user devices, which are referred to as client-side network nodes, have displays on which a displayable area is allocated for displaying events in a workspace. The displayable area for a given user may comprise the entire screen of the display, a subset of the screen, a window to be displayed on the screen and so on, such that each has a limited area or extent compared to the virtually unlimited extent of the workspace.

The collaboration environment can also include conferencing and scheduling systems 105 connected through the network. Users can schedule the collaboration meetings using a meeting scheduling system such as Micorsoft Outlook™ Google Calendar™ etc. Using a meeting scheduling system, a meeting owner (a user who sets up the meeting) can send invites to other users to participate in the collaboration session. The meeting can also identify a meeting room for the collaboration session and assign other resources for the meeting such as one or more digital displays. The technology disclosed can also use conferencing systems such as Cisco WebEx™ Microsoft Skype™ to allow voice and video communication between the meeting participants. When the meeting starts, the meeting participants can join the collaboration session using the devices 102a, 102b, 102c, 102d, or 102e.

The large format displays 102c, 102d, 102e sometimes referred to herein as “walls,” are controlled by respective client-side, network nodes, which in turn are in network communication with a central collaboration server 107 configured as a server-side network node, which has accessible thereto a database 108 storing a log of entries and a database 109 storing spatial event stack for one or more workspaces. The log of entries database 108 stores interaction events data.

As used herein, a network node is an active electronic device that is attached to a network, and is capable of sending, receiving, or forwarding information over a communications channel. Examples of electronic devices which can be deployed as network nodes, include all varieties of computers, work stations, laptop and desktop computers, hand held computers and smart phones. As used herein, the term “database” does not necessarily imply any unity of structure. For example, two or more separate databases, when considered together, still constitute a “database” as that term is used herein.

The collaboration workspace technology described above can be used for collaboration in a wide variety of environments. For example, the technology can be used to conduct collaboration sessions in an enterprise environment in which employees of an organization or other groups participate from one or more office locations or remote locations around the world, simultaneously and at different times, by interacting with a collaboration workspace in the same or different virtual locations. Also, the collaboration technology can be used in an educational environment such as to deliver a lecture in one or more lecture theaters and remote locations. The teacher and students can connect to the collaboration session using their respective computing devices from one or more lecture theaters or remote locations around the world. It is however, difficult to determine whether the collaboration technology such as presented in FIG. 1A is being effectively utilized during collaboration sessions. For example, a project manager or an executive, would like to know how effectively a team is collaborating on a project. A highly collaborative team is an important indicator that the project is expected to meet quality, cost and schedule goals. In an educational environment, a teacher would like to know the collaboration level of students in a lecture. A student who is engaged during the lecture by viewing the content delivered by the teacher on her computing device is more likely to perform well.

The participants in a collaboration session can perform a variety of interactive tasks in the workspace. For example, a user can touch a document in the workspace to open that document, annotate on the document that is open in the workspace, or share the document with other users, etc. A task performed by a user can result in a number of interaction events generated by the system. Additionally, the technology disclosed enables multiple users to interact with the collaboration workspace at the same time. It is difficult to identify the collaboration level of participants when so many interaction events are generated during collaboration sessions.

The technology disclosed can include a classification engine 106 to classify the interaction events into categories. The classification of events into categories enables the system to determine various types of interactions events occurring in a collaboration session. This can help in determining the level of collaboration within the group of users participating in the collaboration session. The technology disclosed enables the organizations to determine a score for collaboration sessions that can indicate the level of participation of the users in the collaboration session. The technology disclosed can also determine a score per participant to identify the level of engagement of the user in the collaboration session.

An example of a collaboration workspace including a “Spatial Event Map” data structure is referred to for the purposes of description of the technology. The spatial event map contains information to define objects and events in a workspace. The spatial event map can be used to generate an event log or a log of entries which identifies an event comprising data specifying virtual coordinates of location within the workspace at which an interaction with the workspace is detected, data specifying a type of interaction, a graphical object associated with the interaction, and a time of the interaction. It is useful to consider the technology from the point of view of space, events, maps of events in the space, and access to the space by multiple users, including multiple simultaneous users. We now present description of these elements.

Space: In order to support an unlimited amount of spatial information for a given collaboration session, we provide a way to organize a virtual space termed the workspace, which can for example be characterized by a 2-dimensional Cartesian plane with essentially unlimited extent in one or both of the dimensions for example, in such a way that new content can be added to the space, that content can be arranged and rearranged in the space, that a user can navigate from one part of the space to another, and that a user can easily find needed things in the space when it is needed.

Events: Interactions with the workspace are handled as events. People, via tangible user interface devices such as touchscreens on digital display walls, desktop and laptop computers, hand held computing devices, cell phones, and other systems can interact with the workspace. The interaction events (or simply referred to as events) described herein include the events that are generated as a result of the interaction of users with the workspace displayed on digital displays (or walls) or computing devices. In the technology disclosed, when a user interacts with a file object displayed on a workspace to open the file or save the file, the system generates an interaction event when user touches the workspace or performs a gesture to interact with the workspace.

Map: A map of events in the workspace can include the sum total of discrete spatial events. When the persistent spatial events for a workspace are available, then that workspace can be “mapped” to a display or screen that has a displayable area of specific size, and that identifies a location or area in the workspace to be displayed in the displayable area.

Multi-User Access: One key characteristic is that all users, or multiple users, who are working on a workspace simultaneously, should be able to see the interactions of the other users in near-real-time way. The spatial event map allows users having displays at different physical locations to experience near-real-time events, including both persistent and ephemeral events, within their respective displayable areas, for all users on any given workspace.

Interaction events have data that can define or point to a target graphical object to be displayed on a physical display, and an action as creation, modification, movement within the workspace and deletion of a target graphical object, and metadata associated with them. Metadata can include information such as originator, date, time, location in the workspace, event type, security information. The location in the workspace can be identified by virtual coordinates of location within the workspace at which an interaction with the workspace occurred. The technology disclosed includes the logic to map the local coordinates of the interaction at a client device to virtual coordinates in the workspace. The events metadata can also include the type of interaction. The system includes the logic to define various types of interactions, for example drawing, writing or annotating on the workspace; adding a digital asset such as a webpage, video, or a document; or moving/arranging objects on the workspace. The event metadata also includes logic to identify digital assets or objects associated with the interaction event. The event metadata can include the name and/or identifier of the organization where the system is deployed. The event metadata can also include the workspace identifier.

The event metadata can include information about the user who performed the event such as the location of the user and whether the user performed the event using a digital display wall, a laptop computer or a handheld device such as a tablet or a cell phone. Events can also be referred to as an activity. The system can also determine whether an event occurred during a multi-user collaboration session, i.e. during a meeting in which two or more users participate or a single user collaboration session also referred to as a single user session. The above event metadata information can be stored as part of the event metadata (also referred to as log of entries). The system can assign weights to events to identify their relative importance. In one embodiment, an event is assigned the same weight across all workspaces in the organization. In another embodiment, the weights can be assigned according to their importance in a particular department, group or a team within the organization. In yet another embodiment, the weights can be assigned based on the time at which the event occurred. For example, a create event that occurred during a multi user collaboration session is given a higher weight as it represents a higher level of collaboration within the team and a create event that occurred in a single user collaboration session is given a lower weight. We now describe a collaboration environment which can use the elements described above to enable collaboration sessions.

Tracking events in a workspace enables the system to not only present the spatial events in a workspace in its current state, but to share it with multiple users on multiple displays, to share relevant external information that may pertain to the content, and understand how the spatial data evolves over time. Also, the spatial event map can have a reasonable size in terms of the amount of data needed, while also defining an unbounded workspace.

There can be several different kinds of events in the system. Events can be classified as persistent events, also referred to as history events, that are stored permanently, or for a length of time required by the system for maintaining a workspace during its useful life. Events can be classified as ephemeral events that are useful or of interest for only a short time and shared live among other clients involved in the session. Persistent events may include history events stored in an undo/playback event stream, which event stream can be the same as or derived from the spatial event map of a session. Ephemeral events may include events not stored in an undo/playback event stream for the system. A spatial event map, or maps, can be used by a collaboration system to track the times and locations in the workspace in some embodiments of both persistent and ephemeral events on workspaces in the system.

The collaboration system can generate a large number of events during a collaboration session. To effectively determine the utilization of the collaboration system and the contribution of different users in the collaboration system, it is useful to categorize the interaction events. This enables the technology disclosed to determine collaboration scores of different users as well as determine collaboration patterns of a team or a group of users. We now present some examples of categories to classify interaction events. Additional categories can be identified to classify the interaction events.

Categories of Events: The technology disclosed can classify the events into categories (also referred to as bins or classes) wherein the classifications correlate with a likelihood the entry represents a substantive contribution to the collaboration workspace. Some examples of categories are create events, curate events, review events, present events, and administration events. Other examples of categories can include converse, view, participate, share, etc. The system can include further categories to classify events. The system can use one or more event metadata described above to classify the event into a category. In one embodiment, one event is classified in one category i.e., there is a one to one mapping from events to categories. In another embodiment, an event can be classified into more than one category. The system can assign weights to categories according to their relative importance. In one embodiment, a same weight is assigned to a category across all workspaces in the organization. In another embodiment, a category can be assigned a higher weight in a department or a team according to its relative importance. For example, the “present” category can be assigned a higher weight in a sales department of an organization as compared to other departments or teams. We provide a brief description of categories below:

Create: A “create” category includes events that are related to initial content creation to populate the workspace. For example, this category can include events related to rough sketches, annotations and text on the workspace. A list of example activities in the create category is presented below:

Browser_Add notecard

Browser_Add Text

Browser_Add webpage

Browser_Draw/write in workspace

Portal_Create workspace

Portal_Duplicate Workspace

Wall_Add notecard

Wall_Add Text

Wall_Draw/write in workspace

Wall_Duplicate

Curate: A “curate” category includes events related to managing, moving, organizing content in the workspace. A list of example activities in the curate category is presented below:

Browser_Add location marker

Browser_Attach

Browser_Group Document

Browser_Group Select

Browser_Undo

Browser_Upload file

Portal_Send to wall

Wall_Add Canvas

Wall_Delete content

Wall_Erase

Wall_Pin content

Review: A “review” category includes review of content in the workspace during a multi-user collaboration session that includes two or more participants. In one embodiment, as the number of participants in the collaboration session increases, the weights of events in this category can increase accordingly. A list of example activities in the review category is presented below:

Browser_Comment

Portal_Accept invite to Org

Portal_Add Collaborator

Portal_Assign Favorite Workspaces (Star)

Portal_Invite to Org

Wall_Comment

Wall_Snapshot

Present: Events in a “present” category can occur towards the end of a project when the team has created, curated and reviewed the content in the workspace. The goal of the events in this category is to share the results of prior collaboration sessions with one or more members of a team. A list of example activities in the present category is presented below:

Browser_Follow User

Browser_Meet Audio

Browser_Meet Video

Browser_Present

Browser_Room List

Browser_Start Screencasting

Wall_Follow User

Wall_Meet Video

Wall_Present

Administration: The events in and “administration” category include activities that are carried out to manage the workspace. For examples, the events can include setting permissions of members of a team or users participating in a collaboration session. This category can include events that are related to enabling the collaboration sessions. An example activity in the administration category is “Portal Edit User settings”.

FIG. 1B illustrates the same environment as in FIG. 1A. The application running at the collaboration server 107 can be hosted using Web server software such as Apache or nginx. It can be hosted for example on virtual machines running operating systems such as LINUX. The server 107 is heuristically illustrated in FIG. 1B as a single computer. However, the server architecture can involve systems of many computers, each running server applications, as is typical for large-scale cloud-based services. The server architecture includes a communication module which can be configured for various types of communication channels, including more than one channel for each client in a collaboration session. For example, near-real-time updates across the network, client software can communicate with the server communication module via using a message-based channel, based for example on the Web Socket protocol. For file uploads as well as receiving initial large volume workspace data, the client software can communicate with the server communication module via HTTP. The server can run a front-end program written for example in JavaScript and HTML using Node.js, support authentication/authorization based for example on Oauth, and support coordination among multiple distributed clients. The front-end program can be written using other programming languages and web-application frameworks such as in JavaScript served by Ruby-on-Rails. The server communication module can include a message-based communication protocol stack, such as a Web Socket application, that performs the functions of recording user actions in workspace data, and relaying user actions to other clients as applicable. This system can run on the node.JS platform for example, or on other server technologies designed to handle high-load socket applications.

The log of entries database 108 can be used to accumulate records that identify events in the collaboration workspace including the virtual space and graphical objects distributed at virtual coordinates in the virtual space. Examples of graphical objects are presented above in description of FIG. 1A, such as images, music, video, documents, application windows and/or other media. Other types of graphical objects can also exist on the workspace such as annotations, comments, and text entered by the users. The entries in the log of entries can include data for interaction events. The examples of interaction event data are presented above. The event data entry in the log of entries can include virtual coordinates of location within the workspace at which the interaction with the workspace occurred, data identifying a type of interaction, a graphical object associated with the interaction, and a time of interaction. In one embodiment, the entries for interaction events in the log of entries can also include data identifying the organization name or identifier, the workspace name or identifier, a client identifier, and one or more participants user names or identifiers. In one embodiment, the location data for the events is stored in the event map stack database 109 which is linked to the log of entries database 108.

We present five example entries for interaction events in the log of entries database 108. In other embodiments, additional metadata or fewer metadata as shown in the examples below can be stored for interaction events. Each entry indicates a timestamp for the interaction event, a deployment region or country, an organization identifier, a workspace identifier, a client type identifier, an activity name, and a user identifier.

{“timestamp”:“2019-06-
01T11:02:41.401Z”,“deployment”:“us”,“organization”:143,“workspace”:52589,“
client”:“Wall”,“activity”:“Select Workspace”,“wall”:1960}
{“timestamp”:“2019-06-
01T00:23:40.793Z”,“deployment”:“us”,“organization”:2345,“workspace”:74565,
“client”:“Browser”,“activity”:“Add Text”,“user”:27808}
{“timestamp”:“2019-06-
01T00:29:44.796Z”,“deployment”:“us”,“organization”:2345,“workspace”:74565,
“client”:“Browser”,“activity”:“Upload file”,“user”:27808}
{“timestamp”:“2019-06-
01T00:31:46.162Z”,“deployment”:“us”,“organization”:2345,“workspace”:74565,
“client”:“Browser”,“activity”:“Draw/write in workspace”,“user”:27808}
{“timestamp”:“2019-06-
01T00:31:46.163Z”,“deployment”:“us”,“organization”:2345,“workspace”:74565,
“client”:“Browser”,“activity”:“Draw/write in workspace”,“user”:27808}

The technology disclosed can gather the “user” (or a participant) data from conferencing and scheduling systems 105. In one embodiment, the user information is stored as part of the entries in the log of entries database 108. In another embodiment, the user information can be stored in a separate user database. In such an embodiment, the records in the user data database can be linked to the entries in the log of entries database. The user data can include information such as name of the user, a user identifier, the duration for which the user participated in the collaboration session, a start time when the user joined the meeting, an end time when the user left the meeting, etc. In one embodiment, the technology disclosed can also store a total number of participants for an interaction event, a category of interaction events, or a collaboration session meeting. The system can update this information based on the users joining the meeting and leaving the meeting and use the actual number of participants that were attending the meeting when an interaction event occurred. This information is useful for determining the level of collaboration in a team and can be combined with other event data in the log of entries and event map stack data to determine a collaboration score.

The database 109 stores, for example, a digital representation of workspace data sets for a spatial event map of each session where the workspace data set can include or identify events related to objects displayable on a display canvas. A workspace data set can be implemented in the form of a spatial event stack, managed so that at least persistent spatial events are added to the stack (push) and removed from the stack (pop) in a first-in-last-out pattern during an undo operation. There can be workspace data sets for many different workspaces. A data set for a given workspace can be configured in a database, or as machine readable document linked to the workspace. The workspace can have unlimited or virtually unlimited dimensions. The workspace data includes event data structures identifying objects displayable by a display client in the display area on a display wall, and associates a time and a location in the workspace with the objects identified by the event data structures. Each device 102 displays only a portion of the overall workspace. A display wall has a display area for displaying objects, the display area being mapped to a corresponding area in the workspace that corresponds to a region in the workspace centered on, or otherwise located with, a user location in the workspace. The mapping of the display area to a corresponding area in the workspace is usable by the display client to identify objects in the workspace data within the display area to be rendered on the display, and to identify objects to which to link user touch inputs at positions in the display area on the display.

The server 107 and databases 108 and 109 can constitute a server-side network node, including memory storing a log of events relating to graphical targets having locations in a workspace, entries in the log of entries including a location in the workspace of the graphical target of the event, data identifying a type of interaction event, a time of the event, and a target identifier of the graphical target of the event. Participants related data can also be stored in the database 108 or in a separate database connected to the server 107. The server can include logic to establish links to a plurality of active client-side network nodes, to receive messages identifying events relating to modification and creation of graphical targets having locations in the workspace, to add events to the log in response to said messages, and to distribute messages relating to events identified in messages received from a particular client-side network node to other active client-side network nodes.

The logic in the server 107 can comprise an application program interface, including a specified set of procedures and parameters, by which to send messages carrying portions of the log to client-side network nodes, and to receive messages from client-side network nodes carrying data identifying events relating to graphical targets having locations in the workspace. Also, the logic in the server 107 can include an application interface including a process to distribute events received from one client-side network node to other client-side network nodes.

The events compliant with the API can include a first class of event (history event) to be stored in the log and distributed to other client-side network nodes, and a second class of event (ephemeral event) to be distributed to other client-side network nodes but not stored in the log.

The server 107 can store workspace data sets for a plurality of workspaces, and provide the workspace data to the display clients participating in the session. The workspace data is then used by the computer systems 110 with appropriate software 112 including display client software, to determine images to display on the display, and to assign objects for interaction to locations on the display surface. The server 107 can store and maintain a multitude of workspaces, for different collaboration sessions. Each workspace can be associated with a group of users, and configured for access only by authorized users in the group.

In some alternatives, the server 107 can keep track of a “viewport” for each device 102, indicating the portion of the canvas viewable on that device, and can provide to each device 102 data needed to render the viewport.

Application software running on the client device responsible for rendering drawing objects, handling user inputs, and communicating with the server can be based on HTML5 or other markup based procedures, and run in a browser environment. This allows for easy support of many different client operating system environments.

The user interface data stored in database 109 includes various types of objects including graphical constructs, such as image bitmaps, video objects, multi-page documents, scalable vector graphics, and the like. The devices 102 are each in communication with the collaboration server 107 via a network 104. The network 104 can include all forms of networking components, such as LANs, WANs, routers, switches, WiFi components, cellular components, wired and optical components, and the internet. In one scenario two or more of the users 101 are located in the same room, and their devices 102 communicate via WiFi with the collaboration server 107. In another scenario two or more of the users 101 are separated from each other by thousands of miles and their devices 102 communicate with the collaboration server 107 via the internet. The walls 102c, 102d, 102e can be multi-touch devices which not only display images, but also can sense user gestures provided by touching the display surfaces with either a stylus or a part of the body such as one or more fingers. In some embodiments, a wall (e.g. 102c) can distinguish between a touch by one or more fingers (or an entire hand, for example), and a touch by the stylus. In an embodiment, the wall senses touch by emitting infrared light and detecting light received; light reflected from a user's finger has a characteristic which the wall distinguishes from ambient received light. The stylus emits its own infrared light in a manner that the wall can distinguish from both ambient light and light reflected from a user's finger. The wall 102c may, for example, be an array of Model No. MT553UTBL MultiTaction Cells, manufactured by MultiTouch Ltd, Helsinki, Finland, tiled both vertically and horizontally. In order to provide a variety of expressive means, the wall 102c is operated in such a way that it maintains “state.” That is, it may react to a given input differently depending on (among other things) the sequence of inputs. For example, using a toolbar, a user can select any of a number of available brush styles and colors. Once selected, the wall is in a state in which subsequent strokes by the stylus will draw a line using the selected brush style and color.

In an illustrative embodiment, a display array can have a displayable area totaling on the order of 6 feet in height and 30 feet in width, which is wide enough for multiple users to stand at different parts of the wall and manipulate it simultaneously. Flexibility of expression on the wall may be restricted in a multi-user scenario, however, since the wall does not in this embodiment distinguish between fingers of different users, or styli operated by different users. Thus, if one user places the wall into one desired state, then a second user would be restricted to use that same state because the wall does not have a way to recognize that the second user's input is to be treated differently.

In order to avoid this restriction, the client-side network node can define “drawing regions” on the wall 102c. A drawing region, as used herein, is a region within which at least one aspect of the wall's state can be changed independently of other regions on the wall. In the present embodiment, the aspects of state that can differ among drawing regions include the properties of a line drawn on the wall using a stylus. Other aspects of state, such as the response of the system to finger touch behaviors may not be affected by drawing regions.

We now describe an example in which technology disclosed can be deployed as a distributed collaboration system. The system can include a shared server 107 which can be linked to a number of facilities (e.g. facility 1 and facility 2) which are geographically distributed, and at which display clients are located. For example, Facility 1 may be located in New York City, while Facility 2 may be located in Los Angeles. There may be many other physical locations at which display clients usable in a collaboration system are located. For example, Facility 1 can include a first room, a second room and a third room. Facility 2 can include a first room, a second room, and a third room. The first room in Facility 1 can include a large-format display that is implemented using a plurality of displays. The second room in Facility 1 can include a single screen, intermediate format display. The third room in Facility 1 may be a private office or other room in which the personal computer or laptop can be utilized as the display client for a session interacting in a chosen workspace. Facility 2 in this illustration is like Facility 1, and includes a first room, a second room and a third room. The first room in Facility 2 includes a large-format display that is implemented using a plurality of displays. The second room in Facility 2 includes a single screen, intermediate format display. The third room in Facility 2 may be a private office or other room in which the personal computer, laptop, mobile pad, or mobile phone can be utilized as the display client for a session.

FIG. 2 is a flowchart illustrating logic executed by the server. The logic can be implemented using processors programmed using computer programs stored in memory accessible to the computer systems and executable by the processors, by dedicated logic hardware, including field programmable integrated circuits, and by combinations of dedicated logic hardware and computer programs. As with all flowcharts herein, it will be appreciated that many of the steps can be combined, performed in parallel or performed in a different sequence without affecting the functions achieved. In some cases, as the reader will appreciate, a re-arrangement of steps will achieve the same results only if certain other changes are made as well. In other cases, as the reader will appreciate, a re-arrangement of steps will achieve the same results only if certain conditions are satisfied. Furthermore, it will be appreciated that the flow chart herein shows only steps that are pertinent to an understanding of the invention, and it will be understood that numerous additional steps for accomplishing other functions can be performed before, after and between those shown.

The flowchart in FIG. 2 illustrates basic logic executed on the server-side when users interact with the workspace thus, causing generation of events which are then sent to the server via API compliant messages. In this flowchart we illustrate logic executed at the server side to accumulate entries (or records) that identify events. The process starts at step 201 in which the server receives entries corresponding to interaction events. We have presented above examples of data that can be sent from clients to the server as part of interaction event entries. In parallel, at step 205, the server receives data from scheduling and conferencing systems. The data received from the scheduling and conferencing systems can include information about users that participate in the collaboration sessions as described above. The technology disclosed matches entries in the log of entries and the user data received from the meeting and scheduling systems to link the entries in the log of entries with the user data (step 210). For example, for a particular interaction event entry, this matching can determine the identification of users who participated in the collaboration session. These participants include all users that are logged into the collaboration meeting when the interaction event occurred. In one embodiment, the system can merge entries in the log of entries with matching meeting data from the scheduling and conferencing systems. In another embodiment, the technology disclosed can link the matching entries in the log of entries with the meeting data from the scheduling and conferencing systems which is stored in a separate database.

In a next step 215, the system determines the users related to the interaction events for a predetermined period of time such as for example, 5 minutes, 30 minutes or a custom time duration between a start time and an end time. Following this, the system determines the types of interactions performed by the users by matching the user data with the interaction event metadata (step 220). The system can access data from the event map stack database 109 to identify the virtual coordinates of the workspaces for the users during the selected time duration. This data can enable the system to identify the level of participation of users in collaboration sessions. If the viewports data of the user indicates that they were viewing the portion of the workspace where the interaction events were occurring, then this means that the participation level of users in the collaboration session is high. In addition, the system can identify users who interacted with the workspace during the selected time duration by parsing the log of entries for the user identifier and matching the user identifier with the data received from scheduling and collaboration systems. By applying the logic described in the above steps, the system can not only identify the users who participated in a meeting but also the participants who were viewing the content that was being presented or interacted with during the meeting. Additionally, the system can identify users who interacted with the workspace to generate interaction events. Thus, the technology disclosed can combine the interaction events data from the log of entries database with the spatial event map data and the data from scheduling and conferencing systems to determine the participation level of users in a collaboration session.

At a step 225, the system applies the log of entries to a classification engine having access to the log of entries. The classification engine generates grouping of the events that are identified by entries in the log of entries as a function of the type of interaction. As described above, the events can be grouped into categories using event metadata such as the type of activity performed in the interaction event. Examples of categories include, create, curate, review, present, and administration. A category score can be determined for each category by calculating a weighted sum of the interaction events in that category. In one embodiment, each event is assigned a same score and therefore each interaction event contributes equally to the category score. In another embodiment, the interaction events can be assigned different weights according to their respective importance.

Finally, at a step 230, the collaboration score for the collaboration session is determined. Note that the collaboration score is for the duration of time selected at the step 215. In one embodiment, the system determines the collaboration score by summing the category scores calculated at step 225. In one embodiment, all the categories are assigned same weight. In another embodiment, different weights can be assigned to categories based on their relative importance. Various criteria can be used to determine weights for categories. For example, a higher weight can be assigned to presentation category if the group of people participating in the collaboration session belong to sales department of an organization. The weights can also be assigned based on the number of users participating in a collaboration session. In one embodiment, the system can assign weights to the interaction events or the categories of the interaction events based on multi-user participation or single-user participation in a collaboration session. This can be used to reflect the impact of the activities on large number of users. For examples, the interaction events or the category of interaction events can be assigned a higher score if more participants are attending the meeting when the interaction events occurred. If only one user was working on the collaboration workspace when the event occurred, then the interaction event or the category of interaction event to which the event belongs can be assigned a lower weight to reflect the relatively less impact of the interaction event.

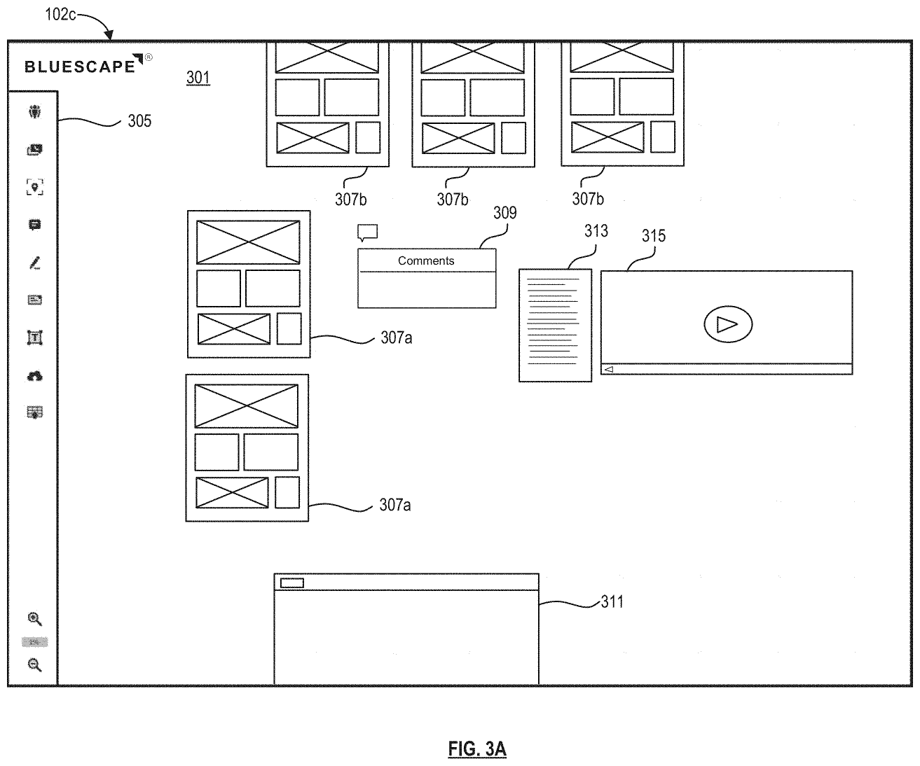

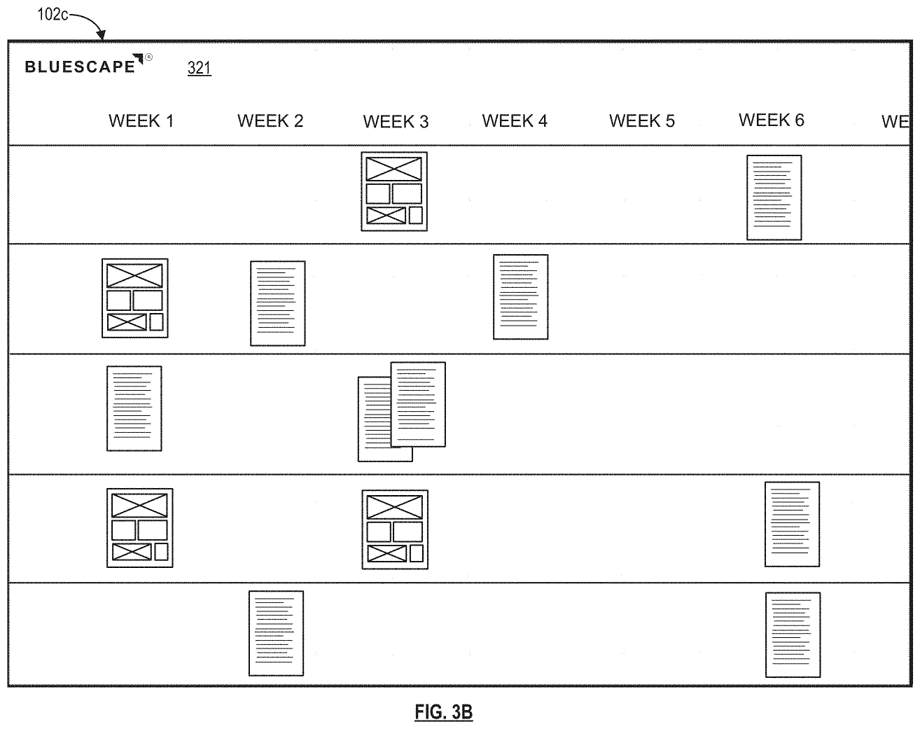

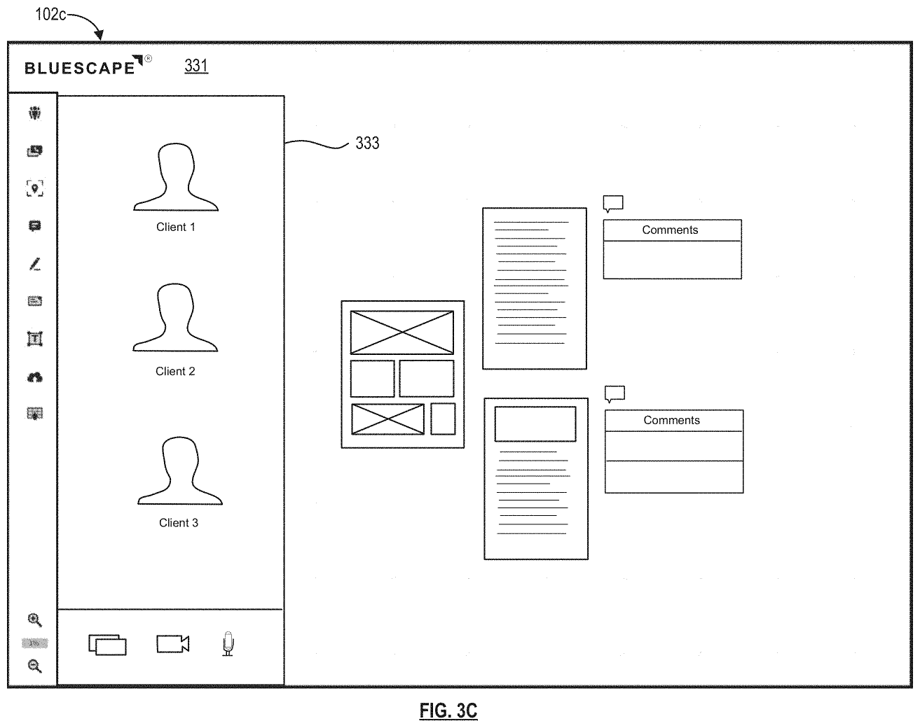

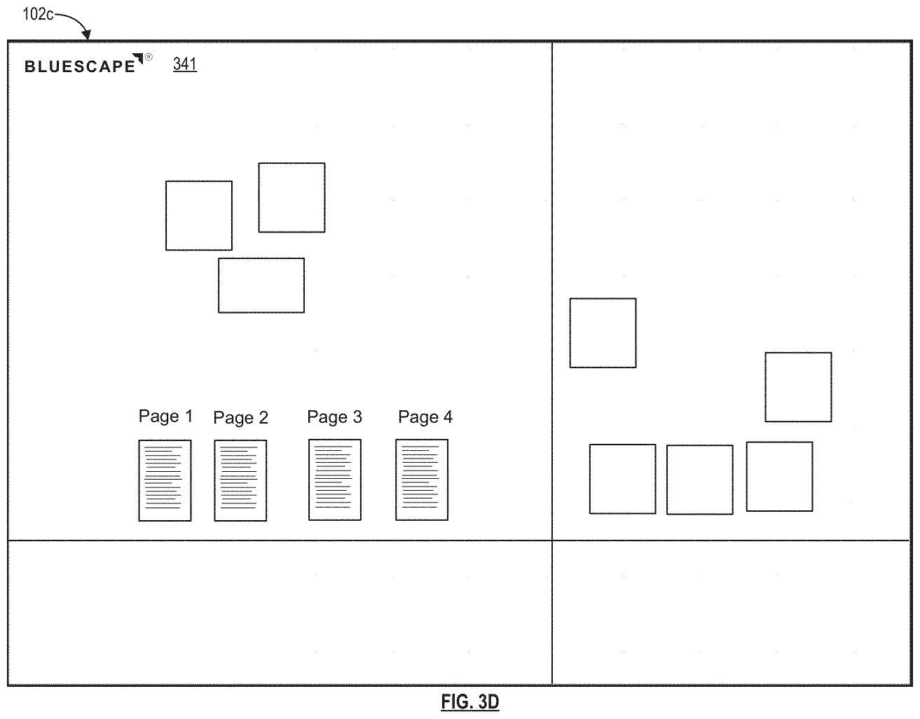

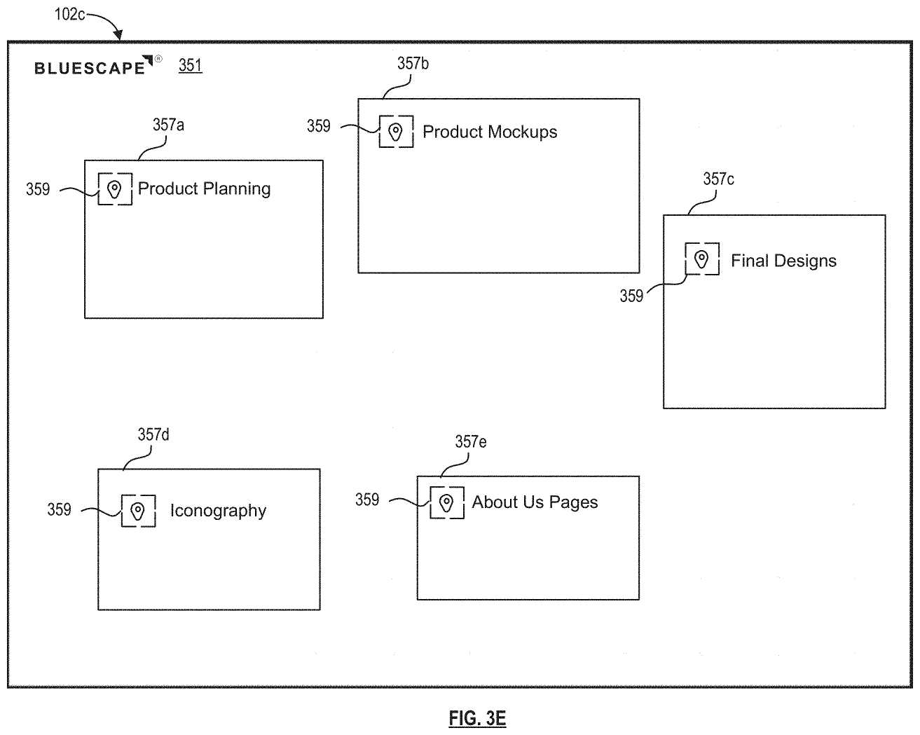

FIGS. 3A to 3E present examples of workspaces displayed on the digital wall 102c. In FIG. 3A, a workspace 301 is shown. The workspace includes a toolbar 305 that includes tools for writing, annotating, and performing other operations on the workspace. There are two graphical objects 307a displayed on the digital display. Additionally, three graphical objects 307b are partially displayed on the digital display as their top portions are positioned outside the viewport of the workspace displayed on the digital display. The workspace can have a virtually unlimited area as described above. A comment box 309 can display comments entered by a user who participates in the collaboration session. A document 313, a browser window 311 and a video 315 are also displayed on the workspace 301. FIG. 3B presents another example of a workspace 321 displayed on the digital display 102c. This example workspace illustrates multiple graphical objects and documents according to a timeline. This workspace can show the content (graphical objects, documents, etc.) added to a workspace by multiple users. A row can represent the content added or edited by a user over a period of time.

FIG. 3C illustrates an example workspace 331 that includes a collaboration user interface 333. The collaboration user interface 333 shows avatars or pictures of users participating in a collaboration session. The collaboration user interface also shows various tools for screen sharing, video camera, microphone at the bottom. The workspace 331 includes a graphical object, documents and user comments. FIG. 3D illustrates a workspace 341 displayed on the digital screen 102c. The workspace 341 includes graphical objects and documents organized into multiple partitions of the workspace. FIG. 3E presents a workspace 351 which includes a high-level view of five workspaces 357a, 357b, 357c, 357d, and 357e. The five workspaces can represent content related to different departments, teams, projects, or tasks in a project. For example, the five workspaces in FIG. 3E can include content related to different tasks in a product development project such as product planning, product mockups, final designs, iconography, and about us pages, respectively. Each workspace can include a user interface element 359 that allows a participant to follow that workspace. For example, a participant joining a collaboration session can click or touch the user interface element 359 to follow that particular workspace. This will display the content of that workspace on the display of the participant's computing device or digital display wall.

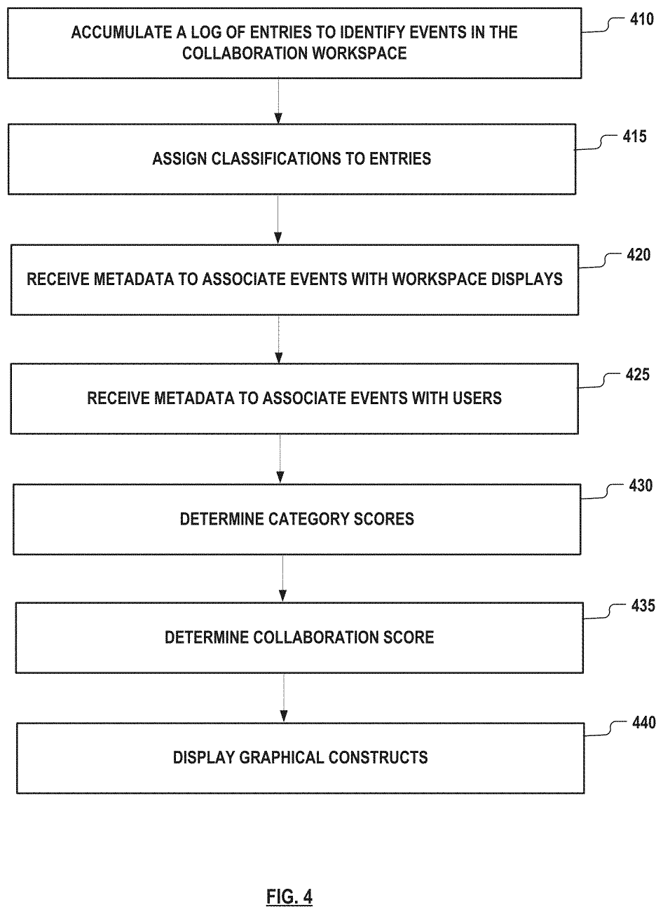

FIG. 4 presents a flowchart of process steps that can be executed by one or more processors to determine a collaboration score. In one embodiment, the technology disclosed includes a data structure to accumulate interaction events as entries. An interaction event entry can identify an event comprising data specifying virtual coordinates of location within the workspace at which an interaction with the workspace is detected, data identifying a type of interaction, a graphical object associated with the interaction, and a time of the interaction (step 410). Accumulating the events includes receiving messages according to a message protocol identifying events for interactions detected on a part of the workspace being rendered on the interactive workspace display controlled by the client processor. The message can be received by a communication link from a client processor controlling an interactive workspace display. The system can store the events received in the messages to the log of entries. The system includes logic to parse the messages according to the message protocol to produce entries for the log of entries. The message protocol can comprise message formats carrying parameters for an application program interface API, the API including parameters and procedures to render parts of the workspace on workspace displays.

The process further includes assigning classification to entries in the log of entries according to the data identifying a type of interaction. The classifications can be assigned according to relative timing of the interactions with other interactions represented by other entries. The classifications can include a plurality of categories, including create events, curate events, review events, present events, and administration events (step 415). The process includes receiving metadata associating events in the log with workspace displays at which the events for interactions are detected. The classification engine further classifies the events according to workspace display (step 420). The process includes receiving metadata associating events in the log with users associated with the interactions (step 425). In one embodiment, the metadata associating events in the log with users can comprises scheduling information linking the workspace displays and the users. In another embodiment, the metadata associating events in the log with users can comprise conferencing information linked to the workspace display and the users. The metadata associating events in the log with users can comprises a number of users participating in the collaboration workspace at the time of the interaction.

The process includes determining a category score using a weighted combination of classifications of events according to the time of interaction (step 430). The process further includes determining a collaboration score using a weighted combination of classifications of events according to the time of interaction (step 435). Weights can be assigned to the categories using the number of users participating in a collaboration workspace.

The process further includes displaying a graphical construct as a function of the classifications of the entries in the log of entries (step 440). In one embodiment, the graphical representation can represent the log of entries for an organization according to the time of the interaction and the classifications of the events. In another embodiment, graphical representation can represent the log of entries for a team according to the time of the interaction and the classifications of the events.

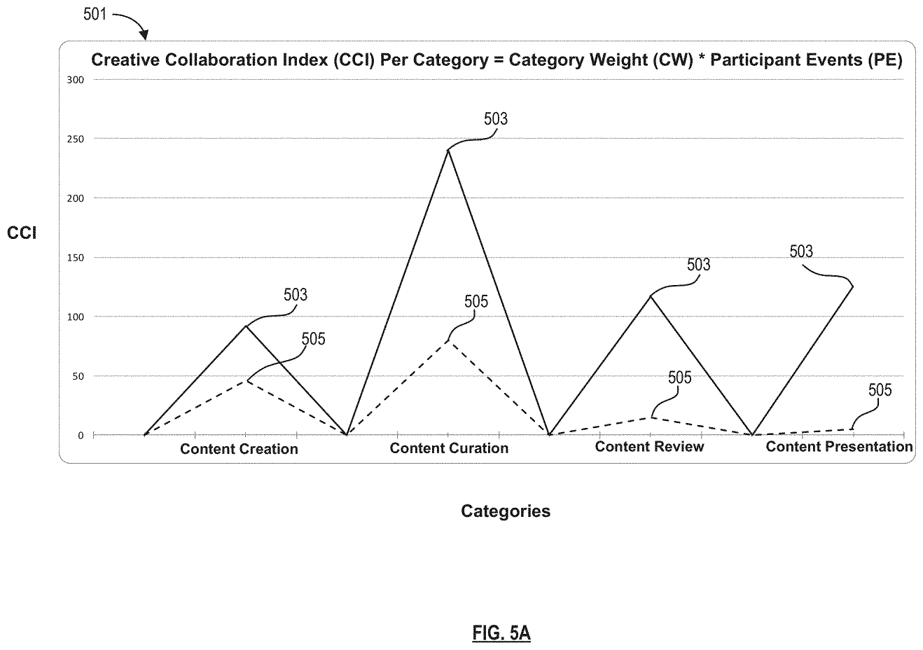

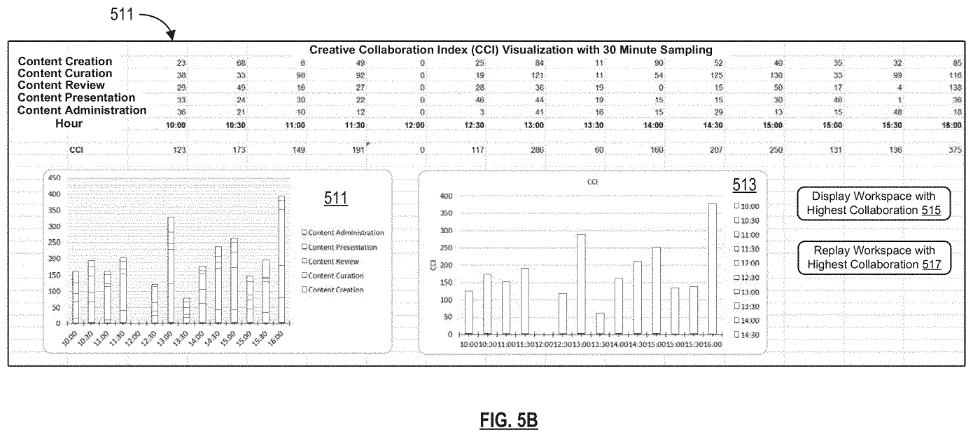

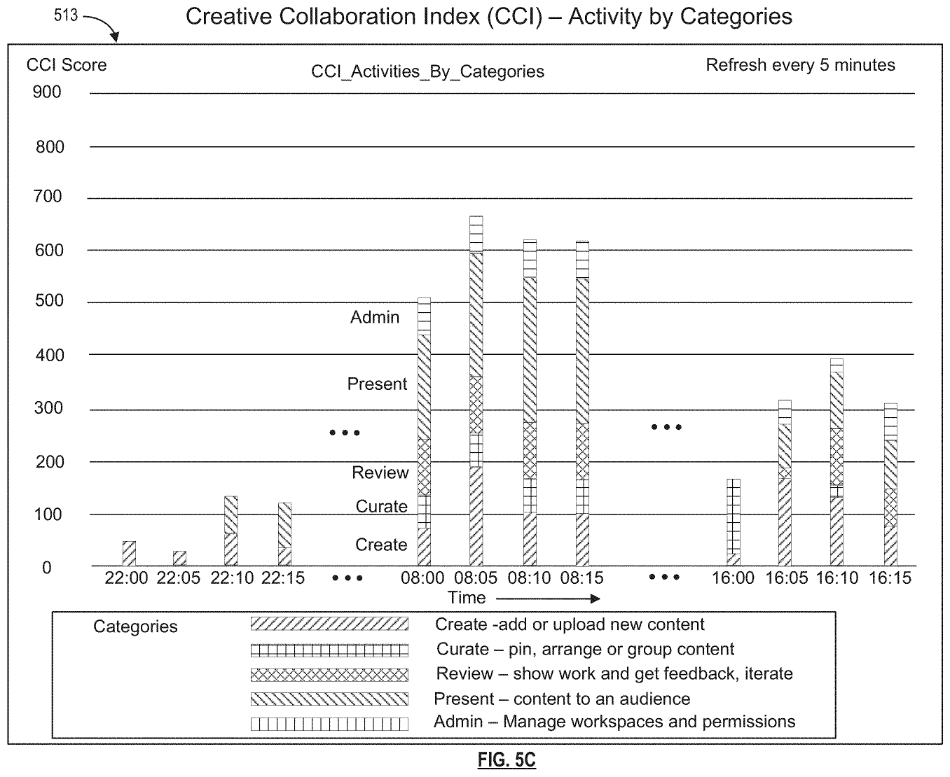

FIGS. 5A to 5E graphical constructs for a user interface as a function of the classifications of the entries in the log of entries. For example, the graphical constructs can represent graphs of collaboration scores (also referred to as creative collaboration index) over a period of time. Also, graphical constructs can be included which display a score in the form of a number or table. FIG. 5A shows one example calculation of graphical construct representing a graph of creative collaboration index (CCI) as a product of category weights (CW) and participant events (PE). The participants events represent interaction events as discussed above. The events can be classified into categories as described above. For a selected time interval such as 1 minute, 5 minutes, 30 minutes or more, the system classifies the interaction events into categories. In one embodiment, the all events are assigned a same weight such as 1. In such an embodiment, the CCI index per category is calculated as a product of the category weight and the number of participant events in the category. In the example, four categories content creation, content curation, content review, and content presentation are shown along horizontal axis of the graph. In this example, each category is assigned a same weight, i.e., 1.67. In other embodiments, each category can be assigned a different weight. The weight can be assigned based on relative importance of a category as described above. The CCI score for each category is calculated by multiplying its weight with the number of events in that category. For example, CCI score for content creation category is calculated as a product of 1.67 (category weight) and 55 (number of events) resulting in a score of 92. Similarly, the CCI scores of content curation category is calculated by multiplying category weight (1.67) with the number of participating events (144) resulting in CCI score of 240. The number of participating events in content review and content presentation categories are 70 and 75 respectively. Therefore, applying the CCI score calculation results in a CCI score of 117 and 125 for content review and content presentation categories respectively. The CCI scores for the four categories are at the peaks 503 in the graph drawn with a solid line (FIG. 5A).

The graph drawn with a broken line represents the CCI scores per category per person. This is calculated by dividing the CCI score of each category by the number of persons participating in the collaboration session in interaction events for that category. For example, two persons participated in interaction events classified as content creation events. Therefore, content creation category score of 92 is divided by 2 which results in a CCI score per person of 45.83 for content creation category. The per person CCI scores for content curation, content review, and content presentation categories are calculated by dividing their respective scores 240, 117, and 125 by the number of participants 3, 8, and 25 in respective categories. The resulting per person scores for content curation, content review and content presentation categories are 80, 14.58, and 5 respectively. The per person category scores for the four categories are shown at the peaks 505 of the graph illustrated by the broken line in FIG. 5A.

FIG. 5B shows a graphical construct representing a graph 511 illustrating CCI scores per 30 minute time interval. The bar graphs for each 30 minute interval consists of portions for each of the five categories of collaboration. This illustration indicates the proportion of interaction events in each category during a selected time interval. The top portion of FIG. 5B shows the number of interaction event per 30 minute interval. A cumulative CCI score is also shown for each time interval which is the sum of the CCI scores for all categories. A graph 513 is a simplified form of the graph 511 in which bar graphs for each time interval only show cumulative CCI score for that time interval. As described above, the CCI score calculation using 30 minute interval is shown for illustration purposes. In one embodiment, the system can include buttons or other user interface elements such as buttons 515 and 517 displayed on the workspace or with graphs of collaboration index to replay or recreate the workspace in which highest collaboration amongst the team occurred. For example, pressing the button 515 will cause the system to display the workspace at a time of highest collaboration. Similarly, pressing a button 517 can cause the system to replay an animation of the workspace from a historical collaboration session during which the highest collaboration occurred.

Time intervals greater than or less than 30 minutes maybe used for calculation of CCI scores. FIG. 5C is an illustration of a graphical construct representing a graph of CCI scores calculation using a time interval of 5 minutes. The bars representing CCI scores per time interval can include different colors, patterns or shading to indicate the contribution of individual category CCI score in the cumulative CCI score per time interval. We have used a different hatch pattern for each category as shown in the legend below the graph. The length of a bar shows contribution of a category score to the cumulative CCI score. We show bar graphs at five-minute time intervals along horizontal axis at four different times of a day to show the CCI scores. This type of graphical illustrations can help project managers or executives to review the activity on a project. It can be seen that the level of activity is low during late hours (22:00 hours) of the day. During morning (08:00 hours), we can observe a higher level of activities resulting in high CCI scores. The activity level can drop towards the end of the day (16:00 hours). The graphical illustration 513 can be used to determine patterns of collaboration during different days of the week and over longer periods of time such as a month or a quarter.

In one embodiment, the technology disclosed can determine patterns of collaboration among team members working on a project by identifying the sequence of interaction events performed by the participants. The technology disclosed can then map the pattern of collaboration to business processes to determine different forms of collaborations in teams. For example, one form of collaboration can represent a content creation and review process in which there are many stakeholders involved. The technology disclosed includes logic to capture the collaboration patterns and determine the business process pattern such as “content review and approval” or “capture and present” pattern.

The technology disclosed can also capture the different milestones completed by the team using annotations on the workspace or input from external systems such as project management systems or email communications, or communications through other tools such as Slack™, Skype™ etc. The technology disclosed can use team members' names, organization chart and the team to determine level of cross team collaboration.

The technology disclosed can use the above inputs including milestones completed and business process patterns for a team over a period of time and determine how many times the team has gone through different forms of business processes and how successfully the team has completed project milestones. This data can be used to train a machine learning model to determine productivity of the team or success of the project.

The technology disclosed can use the above inputs collected from the workspace events, external systems and patterns of collaborations to determine the level of collaboration, creative activity and desired outcomes from a team. The technology disclosed can also use this data to determines trends in creative activity of a team.

The technology disclosed can also determine temporal patterns of collaboration and activity by the participants within a workspace. This includes collaboration which is primarily contemporaneous in nature or staggered due to factors such as time-zone differences of distributed teams or a combination of the two. In one embodiment, the system can recommend a pattern of collaboration to a team if the creative collaboration index for the team is less than a pre-determined threshold.

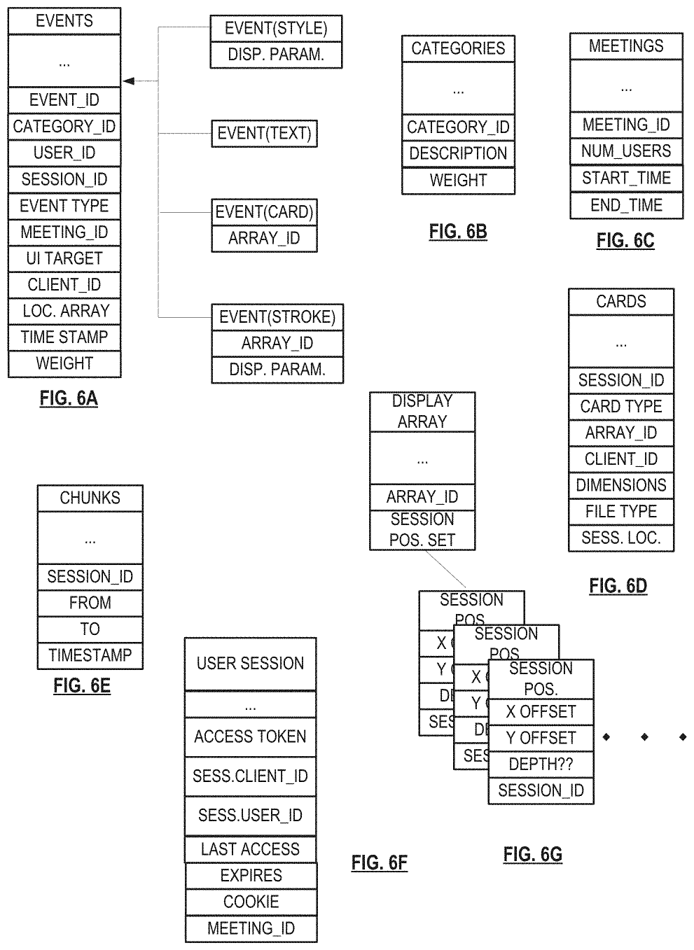

FIGS. 6A-6G represent data structures which can be part of workspace data maintained by a database at the collaboration server 107. In FIG. 6A, an event data structure is illustrated. An event is an interaction with the workspace that can result in a change in workspace data. Interaction events can be classified into categories. An interaction event can occur during a collaboration session, therefore the event can include the meeting identifier identifying the collaboration session. An event can include an event identifier, a category identifier, a user identifier, a timestamp, a session identifier, an event type parameter, the client identifier, a weight of the interaction event, and an array of locations in the workspace, which can include one or more locations for the corresponding event. It is desirable for example that the timestamp have resolution on the order of milliseconds or even finer resolution, in order to minimize the possibility of race conditions for competing events affecting a single object. Also, the event data structure can include a UI target, which identifies an object in the workspace data to which a stroke on a touchscreen at a client display is linked. Events can include style events, which indicate the display parameters of a stroke for example. The events can include a text type event, which indicates entry, modification or movement in the workspace of a text object. The events can include a card type event, which indicates the creation, modification or movement in the workspace of a card type object. The events can include a stroke type event which identifies a location array for the stroke, and display parameters for the stroke, such as colors and line widths for example.

Events can be classified as persistent, history events and as ephemeral events. Processing of the events for addition to workspace data, and sharing among users can be dependent on the classification of the event. This classification can be inherent in the event type parameter, or an additional flag or field can be used in the event data structure to indicate the classification.

A spatial event map can include a log of events having entries for history events, where each entry comprises a structure such as illustrated in FIG. 6A. The server-side network node includes logic to receive messages carrying ephemeral and history events from client-side network nodes, and to send the ephemeral events to other client-side network nodes without adding corresponding entries in the log, and to send history events to the other client-side network nodes while adding corresponding entries to the log.

FIG. 6B presents a category data structure. The category data structure can provide attributes that identify a category such as category identifier, a description of the category and a weight of the category.

FIG. 6C presents a meetings data structure. The meeting data structure can be used to identify a meeting. The system can use the information received from external systems such as scheduling and conferencing systems to identify meeting attributes. The meeting data structure can store a meeting identifier, a number of users participating in the meeting, the start time of the meeting and end time of the meeting.

FIG. 6D illustrates a card data structure. The card data structure can provide a cache of attributes that identify current state information for an object in the workspace data, including a session identifier, a card type identifier, an array identifier, the client identifier, dimensions of the cards, type of file associated with the card, and a session location within the workspace.

FIG. 6E illustrates a data structure which consolidates a number of events and objects into a catchable set called a chunk. The data structure includes a session ID, and identifier of the events included in the chunk, and a timestamp at which the chunk was created.

FIG. 6F illustrates the data structure for links to a user participating in a session in a chosen workspace. This data structure can include an access token, the client identifier for the session display client, the user identifier linked to the display client, a parameter indicating the last time that a user accessed a session, and expiration time and a cookie for carrying various information about the session. This information can, for example, maintain a current location within the workspace for a user, which can be used each time that a user logs in to determine the workspace data to display at a display client to which the login is associated. A user session can also be linked to a meeting. One or more than one users can participate in a meeting. A user session data structure can identify the meeting in which a user participated in during a given collaboration session. Linking a user session to a meeting enables the technology disclosed to determine the identification of the users and the number of users who participated in the meeting.

FIG. 6G illustrates a display array data structure which can be used in association with large-format displays that are implemented by federated displays, each having a display client. The display clients in such federated displays cooperate to act as a single display. The workspace data can maintain the display array data structure which identifies the array of displays by an array ID, and identifies the session position of each display. Each session position can include an x-offset and a y-offset within the area of the federated displays, a session identifier, and a depth.

The system can encrypt communications with client-side network nodes, and can encrypt the database in which the spatial event maps are stored. Also, on the client-side network nodes, cached copies of the spatial event map are encrypted in some embodiments, to prevent unauthorized access to the data by intruders who gain access to the client-side computers.

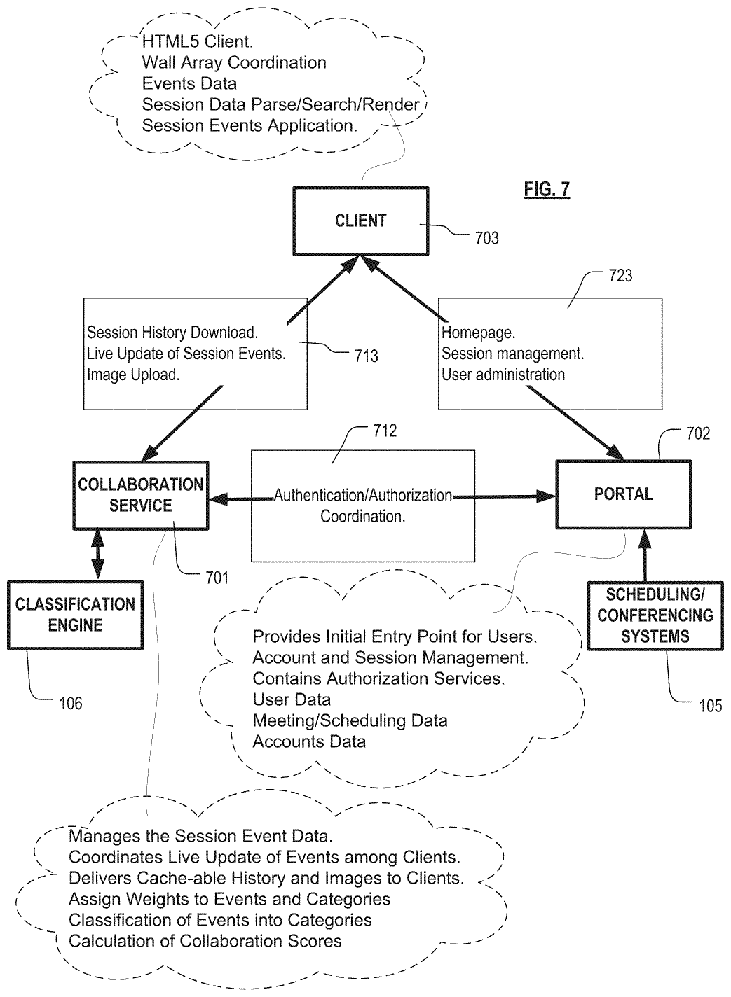

FIG. 7 is a diagram representing a functional architecture for a distributed collaboration system used to create, modify, distribute and display workspace data for a workspace. The basic configuration includes a collaboration service 701 which manages event data executed by a server, such as server 107, a portal service 702 which can be executed by a server such as server 107 or located in other computer systems accessible to the server, such as a peer network node, and a display client 703 located at a client-side network node, at which the user interaction is active. The display client 703 is in communication with the collaboration service 701 and with the portal 702. The communication channel 713 between the display client 703 and a collaboration service 701 manages the download of session history, and the live update of session events. Also, across this channel 713, a display client 703 can upload images that can be associated with events to the collaboration service 701. The display client 703 is in communication with the portal 702 across communication channel 723. The portal 702 manages a homepage for the workspace data, session management and user administration. This portal can be utilized for user login, authentications, and for delivering image files and the like as an alternative to, and in parallel with, the communication channel 713. The collaboration service 701 and portal 702 are in communication across channel 712. The collaboration service 701 and portal 702 manage authentication and authorization protocols, and coordinate session administration, and workspace data management.

The display client 703 can be part of a client-side network node including a physical or virtual computer system having computer programs stored in accessible memory that provide logic supporting the collaboration session, including an HTML 5 client, wall array coordination logic for display array implementations, workspace data parsing searching and rendering logic, and a session events application to manage live interaction with workspace data at the server and the display wall.

The portal 702 can be part of a server-side network node including a physical or virtual computer system having computer programs stored in accessible memory, that provide logic supporting user access to the collaboration server. The logic can include applications to provide initial entry points for users, such as a webpage with login resources, logic to manage user accounts and session anticipation, logic that provides authorization services, such as OAuth-based services, and account data. The portal 702 communicates to scheduling and conferencing systems 105. The portal can therefore, collect user data and meeting data from the scheduling and conferencing systems.

The collaboration service 701 can be part of a server-side network node including, and can manage the session event data, coordinate updated events among clients, deliver catchable history and images to clients, and control access to a database stored in the workspace data. The collaboration service communicates with a classification engine that can classify interaction events into categories.

A spatial event map system can include an API executed in coordination by client-side and server-side resources including any number of physical and virtual machines. One example of an API is described below. An API can be defined in a variety of ways, while including the elements supporting maintenance of a spatial event map in a server-side network node or nodes, and supporting sharing of the spatial event map with one or a plurality of active client-side network nodes. In this example, the API is broken down in this example into processes managed by two servers:

Socket Requests Server (Websockets)—used for updating clients with relevant data (new strokes, cards, clients, etc.) once connected. Also handles the initial connection handshake.

Service Requests Server (HTTP/REST)—used for cacheable responses, as well as posting data (i.e. images and cards)

Client-side network nodes are configured according to the API, and include corresponding socket requests clients and service requests clients.

### History Event

All persistent events are sent as HistoryEvent. This includes for example, moving windows, setting text, deleting windows, creating windows. HistoryEvents are written to the session's history and returned when the history is retrieved. HistoryEvents are sent to the server without an eventId. The server assigns an eventId and broadcasts the event to all clients (including the originating client). New object ids can be reserved using the oid message.

### Basic Message Format

// server <-- client [client-id, “he”, target-id, event-type, event-properties]
client-id - - (string) the ID of the originating client
target-id - - (string) the ID of the target object/widget/app to which this event isrelevant
event-type - - (string) an arbitrary event type
properties - - (object) a JSON object describing pertinent key / values for theevent.
// server --> client[client-id, “he”, target-id, event-id, event-type, event-properties]
client-id - - (string) the ID of the originating client
target-id - - (string) the ID of the target window to which this event is relevant
event-id - - (string) the ID of the event in the database
event-type - - (string) an arbitrary event type
properties - - (object) a JSON object describing pertinent key / values for theevent.

// server−> client format of ′he′ is: [<clientId>, <messageType>, <targetId>, <eventId>,
Note:
The eventId will also be included in history that is fetched via the HTTP API.

### History Events by Object/Application Type

Session

Create - - Add a note or image on the work session
stroke - - Add a pen or eraser stroke on the background

Note

text - - Sets or update the text and/or text formatting of a note.
delete - - Remove the note from the work session
position - - Update the size or location of the note in the work session
pin - - Pin or unpin the note
stroke - - Add a pen or eraser stroke on top of the image

Image

delete - - Remove the note from the work session
position - - Update the size or location of the note in the work session
pin - - Pin or unpin the note
stroke - - Add a pen or eraser stroke on top of the image

### Volatile Event

Volatile events are ephemeral events not recorded in the undo/playback event stream, so they're good for in-progress streaming events like dragging a card around the screen, and once the user lifts their finger, a HistoryEvent is used to record its final place.

// server <--> client[client-id, “ve”, target-id, event-type, event-properties]

client-id - - (string) the ID of the originating client
target-id - - (string) the ID of the target window to which this event is relevant
event-type - - (string) an arbitrary event type
properties - - (object) a JSON object describing pertinent key / values for the event.

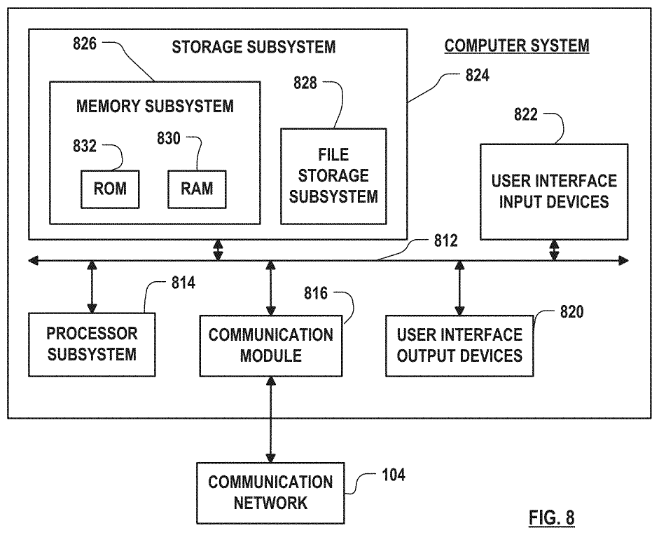

FIG. 8 is a simplified block diagram of a computer system, or network node, which can be used to implement the client-side functions (e.g. computer system 110) or the server-side functions (e.g. server 107) in a distributed collaboration system. A computer system typically includes a processor subsystem 814 which communicates with a number of peripheral devices via bus subsystem 812. These peripheral devices may include a storage subsystem 824, comprising a memory subsystem 826 and a file storage subsystem 828, user interface input devices 822, user interface output devices 820, and a network interface subsystem 816. The input and output devices allow user interaction with the computer system. Communication module 816 provides physical and communication protocol support for interfaces to outside networks, including an interface to communication network 104, and is coupled via communication network 104 to corresponding communication modules in other computer systems. Communication network 104 may comprise many interconnected computer systems and communication links. These communication links may be wireline links, optical links, wireless links, or any other mechanisms for communication of information, but typically it is an IP-based communication network, at least at its extremities. While in one embodiment, communication network 104 is the Internet, in other embodiments, communication network 104 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 822 may include a keyboard, pointing devices such as a mouse, trackball, touchpad, or graphics tablet, a scanner, a touch screen incorporated into the display (including the touch sensitive portions of large format digital display such as 102c), audio input devices such as voice recognition systems, microphones, and other types of tangible input devices. In general, use of the term “input device” is intended to include all possible types of devices and ways to input information into the computer system or onto computer network 104.

User interface output devices 820 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. In the embodiment of FIG. 1B, it includes the display functions of large format digital display such as 102c. The display subsystem may also provide non-visual display such as via audio output devices. In general, use of the term “output device” is intended to include all possible types of devices and ways to output information from the computer system to the user or to another machine or computer system.

Storage subsystem 824 stores the basic programming and data constructs that provide the functionality of certain embodiments of the present invention.

The storage subsystem 824 when used for implementation of server side network-nodes, comprises a product including a non-transitory computer readable medium storing a machine readable data structure including a spatial event map which locates events in a workspace, wherein the spatial event map includes a log of events, entries in the log having a location of a graphical target of the event in the workspace and a time. Also, the storage subsystem 824 comprises a product including executable instructions for performing the procedures described herein associated with the server-side network node.

The storage subsystem 824 when used for implementation of client side network-nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 824 comprises a product including executable instructions for performing the procedures described herein associated with the client-side network node.

For example, the various modules implementing the functionality of certain embodiments of the invention may be stored in storage subsystem 824. These software modules are generally executed by processor subsystem 814.

Memory subsystem 826 typically includes a number of memories including a main random access memory (RAM) 830 for storage of instructions and data during program execution and a read only memory (ROM) 832 in which fixed instructions are stored. File storage subsystem 828 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs, and may be stored by file storage subsystem 828. The host memory 826 contains, among other things, computer instructions which, when executed by the processor subsystem 814, cause the computer system to operate or perform functions as described herein. As used herein, processes and software that are said to run in or on “the host” or “the computer,” execute on the processor subsystem 814 in response to computer instructions and data in the host memory subsystem 826 including any other local or remote storage for such instructions and data.

Bus subsystem 812 provides a mechanism for letting the various components and subsystems of a computer system communicate with each other as intended. Although bus subsystem 812 is shown schematically as a single bus, alternative embodiments of the bus subsystem may use multiple busses.

The computer system itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 110 depicted in FIG. 8 is intended only as a specific example for purposes of illustrating the preferred embodiments of the present invention. Many other configurations of the computer system are possible having more or less components than the computer system depicted in FIG. 8. The same components and variations can also make up each of the other devices 102 in the collaboration environment of FIG. 1, as well as the collaboration server 107 and databases 108 and 109.

Certain information about the drawing regions active on the digital display 102c are stored in a database accessible to the computer system 110 of the display client. The database can take on many forms in different embodiments, including but not limited to a MongoDB database, an XML database, a relational database, or an object oriented database.

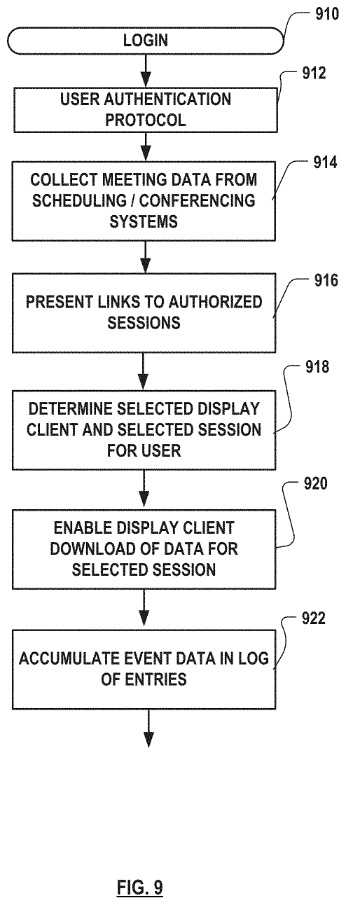

FIG. 9 is a flowchart illustrating logic executed on the server-side when a user joins a session as part of a persistent workspace. The flowchart begins with a login by the user (910), in which the user may enter a user identifier in a web portal access through a device possessed by the user, such as a personal computer, a touchpad, a smart phone, etc. Next, a user authentication protocol is executed (912), where a protocol, for example, can include requiring the user to enter a personal password, to verify that the user is in fact a person who has entered the user identifier. At step 914, the collaboration server, using the portal machine, collects meeting data from a meeting scheduler. The meeting scheduler can be an external system connected to the collaboration server via the portal machine. If a conferencing system is used to connect the meeting participants for voice and/or data communication, the collaboration server can collect meeting information from the conferencing system indicating. Next, the collaboration server, using for example the portal machine, can present links to workspaces in which the authenticated user is authorized to participate (916). Next, the collaboration server can determine a selected display client, and a selected workspace for the user (918). This determination can be made by an exchange of messages between the user possessed machine, and the portal using the communication channel on which the authentication protocol is executed. When the display client and workspace are identified, the collaboration server can enable the display client to download data for the selected workspace (920). Also, the collaboration server can add the client to a live event channel for the selected workspace. The server then accumulates the events data received form the clients in the log of entries (922).

In one example, the process of downloading the workspace data includes delivering the event objects for the session to each display client. Included with the workspace data, a current user location can be provided. Alternatively, the workspace data can be delivered, followed by a sequence of messages which identify to the display client how to compute an offset from a default location, such as at the center of the workspace data, to a current location associated with the user. Each display client then can traverse the event objects to identify those objects having session locations which map to the display area managed by the display client. The logic to traverse the event objects can include an R-TREE search for example, which is configured to find objects in the workspace that map to the display area. The identified objects can then be rendered, possibly communicating with the portal to obtain data relevant to the objects, on the display area managed by the display.

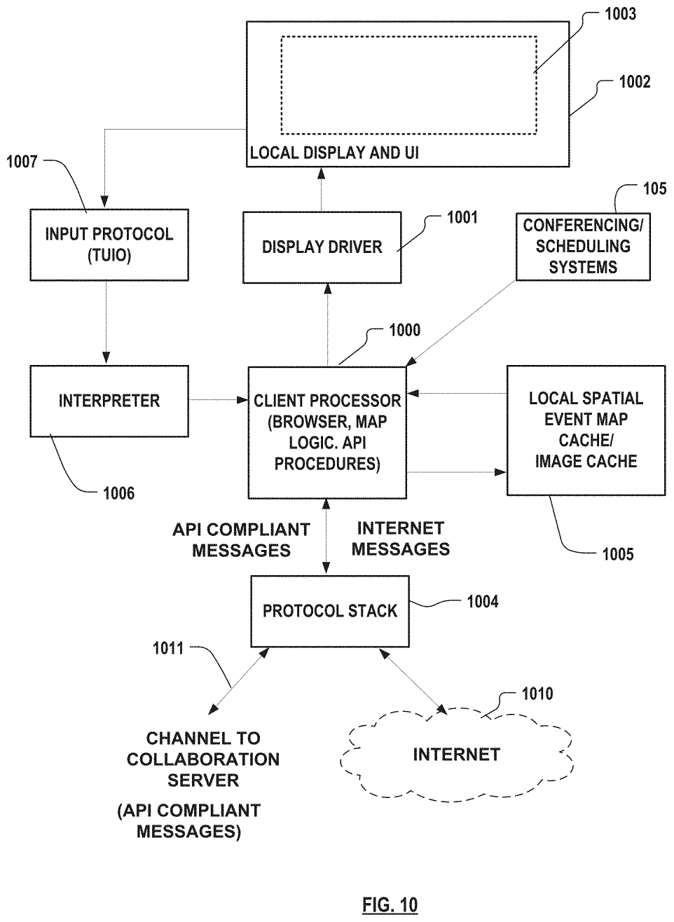

FIG. 10 is a simplified diagram of a client-side network node, including a client processor 1000, a display driver 1001, a local display and user interface such as a touchscreen 1002, a protocol stack 1004 including a communication interface controlled by the stack, local memory 1005 storing a cache copy of the live spatial event map and a cache of images and other graphical constructs used in rendering the displayable area, and input protocol device 1007 which executes a input protocol which translates input from a tangible user input device such as a touchscreen, or a mouse, into a form usable by a command interpreter 1006. A suitable input protocol device 1007 can include software compatible with a TUIO industry-standard, for example for interpretation of tangible and multi-touch interaction with the display wall. The protocol stack 1004 receives API compliant messages and Internet messages from the client processor 1000 and as discussed above includes resources to establish a channel 1011 to a collaboration server across which API compliant messages can be exchanged, and a link 1010 to the Internet in support of other communications that serve the local display 1002. The display driver 1001 controls a displayable area 1003 on the local display 1002. The displayable area 1003 can be logically configured by the client processor or other programming resources in the client-side network node. Also, the physical size of the displayable area 1003 can be fixed for a given implementation of the local display. The client processor 1000 can include processing resources such as a browser, mapping logic used for translating between locations on the displayable area 1003 and the workspace, and logic to implement API procedures.

The client-side network node shown in FIG. 10 illustrates an example including an application interface including a process to communicate with the server-side network node. The client-side network node shown in FIG. 10 illustrates an example configured according to an API, wherein the events include a first class of event designated as history events to be distributed among other client-side network nodes and to be added to the spatial event log in the server-side network node, and a second class of event designated as ephemeral to be distributed among other client-side network nodes but not added to the spatial event log in the server-side network node.

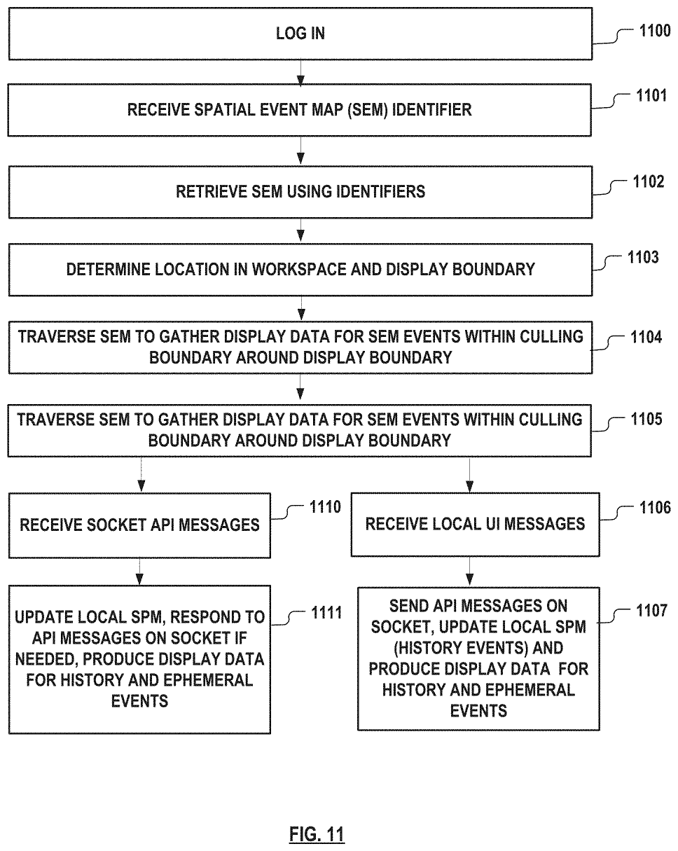

FIG. 11 is a simplified flow diagram of a procedure executed by the client-side network node. The order illustrated in the simplified flow diagram is provided for the purposes of illustration, and can be modified as suits a particular implementation. Many of the steps for example, can be executed in parallel. In this procedure, a client login is executed (1100) by which the client is given access to a specific collaboration session and its spatial event map. The collaboration server provides an identifier of, or identifiers of parts of, the spatial event map which can be used by the client to retrieve the spatial event map from the collaboration server (1101). The client retrieves the spatial event map, or at least portions of it, from the collaboration server using the identifier or identifiers provided (1102).

For example, the client can request all history for a given workspace to which it has been granted access as follows:

curl http://localhost:4545/<sessionId>/history

The server will respond with all chunks (each its own section of time):

[“/<sessionId>/history/<startTime>/<endTime>?b=1”]
[“/<sessionId>/history/<startTime>/<endTime>?b=1”]

For each chunk, the client will request the events:

Curl http: //localhost:4545/<sessionId>/history/<startTime>/
<endTime>?b=<cache-buster>

Each responded chunk is an array of events and is cacheable by the client:

[

[

4,
″sx″,
″4.4″,
[537, 650, 536, 649, 536, 648, ...],
{

“size″: 10,
″color″: [0, 0, 0, 1],
”brush”: 1

},
1347644106241,
″cardFling″

]

]

The individual messages might include information like position on screen, color, width of stroke, time created etc.

The client then determines a location in the workspace, using for example a server provided focus point, and display boundaries for the local display (1103). The local copy of the spatial event map is traversed to gather display data for spatial event map entries that map to the displayable area for the local display. In some embodiments, the client may gather additional data in support of rendering a display for spatial event map entries within a culling boundary defining a region larger than the displayable area for the local display, in order to prepare for supporting predicted user interactions such as zoom and pan within the workspace (1104). The client processor executes a process using spatial event map events, ephemeral events and display data to render parts of the spatial event map that fall within the display boundary (1105). This process receives local user interface messages, such as from the TUIO driver (1106). Also, this process receives socket API messages from the collaboration server (1110). In response to local user interface messages, the process can classify inputs as history events and ephemeral events, send API messages on the socket to the collaboration server for both history events and ephemeral events as specified by the API, update the cached portions of the spatial event map with history events, and produce display data for both history events and ephemeral events (1107). In response to the socket API messages, the process updates the cached portion of the spatial event map with history events identified by the server-side network node, responds to API messages on the socket as specified by the API, and produce display data for both history events and ephemeral events about which it is notified by the socket messages (1111).

Logging in and downloading spatial event map.

1. The client request authorization to join a collaboration session, and open a workspace.

2. The server authorizes the client to participate in the session, and begin loading the spatial event map for the workspace.

3. The client requests an identification, such as a “table of contents” of the spatial event map associated with the session.

4. Each portion of the spatial event map identified in the table of contents is requested by the client. These portions of the spatial event map together represent the workspace as a linear sequence of events from the beginning of workspace-time to the present. The “beginning of workspace-time” can be considered an elapsed time from the time of initiation of the collaboration session, or an absolute time recorded in association with the session.

5. The client assembles a cached copy of the spatial event map in its local memory.

6. The client displays an appropriate region of the workspace using its spatial event map to determine what is relevant given the current displayable area or viewport on the local display.

Connecting to the session channel of live spatial event map events:

1. After authorization, a client requests to join a workspace channel.

2. The server adds the client to the list of workspace participants to receive updates via the workspace channels.

3. The client receives live messages from the workspace that carry both history events and ephemeral events, and a communication paradigm like a chat room. For example, a sequence of ephemeral events, and a history event can be associated with moving object in the spatial event map to a new location in the spatial event map.

4. The client reacts to live messages from the server-side network node by altering its local copy of the spatial event map and re-rendering its local display.

5. Live messages consist of “history” events which are to be persisted as undue-double, recorded events in the spatial event map, and “ephemeral” events which are pieces of information that do not become part of the history of the session.

6. When a client creates, modifies, moves or deletes an object by interaction with its local display, a new event is created by the client-side network node and sent across the workspace channel to the server-side network node. The server-side network node saves history events in the spatial event map for the session, and distributes both history events and ephemeral events to all active clients in the session.

7. When exiting the session, the client disconnects from the workspace channel.

A collaboration system can have many, distributed digital displays which are used both to display images based on workspace data managed by a shared collaboration server, and to accept user input that can contribute to the workspace data, while enabling each display to rapidly construct an image to display based on session history, real time local input and real-time input from other displays.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “indicate” is used herein to mean the same as “identify”.

Also as used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the invention. In addition, any and all variations described, suggested or incorporated by reference herein with respect to any one embodiment are also to be considered taught with respect to all other embodiments. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A method for monitoring a collaboration system including configured for displaying views of a collaboration workspace including graphical objects distributed at virtual coordinates in the collaboration workspace on an interactive workspace display or interactive workspace displays in a network, comprising
accumulating at a server, a log of entries to identify events in the collaboration workspace, where an entry in the log of entries which identifies an event comprising data specifying virtual coordinates of location within the workspace at which an interaction with the workspace is detected, data identifying a type of interaction, a graphical object associated with the interaction, and a time of the interaction;
assigning classifications to entries in the log according to the data identifying a type of interaction; and
displaying a graphical construct as a function of the classifications of the entries in the log of entries.

2. The method of claim 1, wherein the classifications are assigned according to relative timing of the interactions with interactions represented by other entries.

3. The method of claim 1, wherein the classifications include a plurality of categories, including create events, curate events, review events, present events, and administration events.

4. The method of claim 1, the method further including receiving metadata associating events in the log with workspace displays at which the interactions identified in the events are detected, and the classification engine further classifies the events according to workspace display.

5. The method of claim 1, the method further including receiving metadata associating events in the log with users associated with the interactions and the classification engine further classifies the events according to workspace display.

6. The method of claim 5, wherein the metadata associating events in the log with users comprises scheduling information linking the workspace displays and the users.

7. The method of claim 5, wherein the metadata associating events in the log with users comprises conferencing information linked to the workspace display and the users.

8. The method of claim 1, wherein the metadata associating events in the log with users comprises a number of users participating in the collaboration workspace at the time of the interaction.

9. The method of claim 1, wherein the graphical representation represents the log of entries for an organization according to the time of the interaction and the classifications of the events.

10. The method of claim 1, wherein the graphical representation represents the log of entries for a team according to the time of the interaction and the classifications of the events.

11. The method of claim 1, the method further including determining a category score using a weighted combination of classifications of events according to the time of interaction.

12. The method of claim 11, the method further including determining a collaboration score using a weighted combination of classifications of events according to the time of interaction.

13. The method of claim 12, the method further including assigning weights to the categories using the number of users participating in a collaboration workspace.

14. The method of claim 1, wherein accumulating the events includes receiving by a communication link from a client processor controlling an interactive workspace display, messages according to a message protocol identifying events for interactions detected on a part of the workspace being rendered on the interactive workspace display controlled by the client processor, for addition to the log of entries; and
parsing the messages according to the message protocol to produce entries for the log of entries.

15. The method of claim 14, wherein the message protocol comprises message formats carrying parameters for an application program interface API, the API including parameters and procedures to render parts of the workspace on workspace displays.

16. A system comprising:
a network node, including memory storing a log of entries to identify events in the collaboration workspace, where an entry in the log of entries which identifies an event comprises data specifying virtual coordinates of location within the workspace at which an interaction with the workspace is detected, data identifying a type of interaction, a graphical object associated with the interaction, and a time of the interaction; and the network node further includes logic to:
assign classifications to entries in the log according to the data identifying a type of interaction; and
display a graphical construct as a function of the classifications of the entries in the log of entries.

17. The system of claim 16, wherein the classifications are assigned according to relative timing of the interactions with interactions represented by other entries.

18. The system of claim 16, wherein the classifications include a plurality of categories, including create events, curate events, review events, present events, and administration events.

19. The system of claim 16, wherein the network node further includes logic to receive metadata associating events in the log with workspace displays at which the interactions identified in the events are detected, and the classifications are assigned according to workspace display.

20. The system of claim 16, wherein the network node further includes logic to receive metadata associating events in the log with users associated with the interactions and the classifications are assigned according to workspace display.

21. The system of claim 20, wherein the metadata associating events in the log with users comprises scheduling information linking the workspace displays and the users.

22. The system of claim 20, wherein the metadata associating events in the log with users comprises conferencing information linked to the workspace display and the users.

23. The system of claim 20, wherein the metadata associating events in the log with users comprises a number of users participating in the collaboration workspace at the time of the interaction.

24. The system of claim 16, wherein the graphical representation represents the log of entries for an organization according to the time of the interaction and the classifications of the events.

25. The system of claim 16, wherein the graphical representation represents the log of entries for a team according to the time of the interaction and the classifications of the events.

26. The system of claim 16, wherein the network node further includes logic to determine a category score using a weighted combination of classifications of events according to the time of interaction.

27. The system of claim 16, wherein the network node further includes logic to determine a collaboration score using a weighted combination of classifications of events according to the time of interaction.

28. The system of claim 16, wherein the network node further includes logic to assign weights to the categories using the number of users participating in a collaboration workspace.

29. The system of claim 16, wherein the network node further includes logic to receive by a communication link from a client processor controlling an interactive workspace display, messages according to a message protocol identifying events for interactions detected on a part of the workspace being rendered on the interactive workspace display controlled by the client processor, for addition to the log of entries; and
parse the messages according to the message protocol to produce entries for the log of entries.

30. The system of claim 29, wherein the message protocol comprises message formats carrying parameters for an application program interface API, the API including parameters and procedures to render parts of the workspace on workspace displays.

31. A product comprising:
non-transitory computer readable memory; and
a machine readable data structure stored in the memory including a log of entries to identify events in the collaboration workspace, where an entry in the log of entries which identifies an event comprises data specifying virtual coordinates of location within the workspace at which an interaction with the workspace is detected, data identifying a type of interaction, a graphical object associated with the interaction, and a time of the interaction; and the product further includes executable instructions to:
assign classifications to entries in the log according to the data identifying a type of interaction; and
display a graphical construct as a function of the classifications of the entries in the log of entries.

32. The product of claim 31, wherein the classifications are assigned according to relative timing of the interactions with interactions represented by other entries.

33. The product of claim 31, wherein the classifications include a plurality of categories, including create events, curate events, review events, present events, and administration events.

34. The product of claim 31, wherein the product further includes executable instructions to receive metadata associating events in the log with workspace displays at which the interactions identified in the events are detected, and the classifications are assigned according to workspace display.

35. The product of claim 31, wherein the product further includes executable instructions to receive metadata associating events in the log with users associated with the interactions and the classifications are assigned according to workspace display.

36. The product of claim 35, wherein the metadata associating events in the log with users comprises scheduling information linking the workspace displays and the users.

37. The product of claim 35, wherein the metadata associating events in the log with users comprises conferencing information linked to the workspace display and the users.

38. The product of claim 35, wherein the metadata associating events in the log with users comprises a number of users participating in the collaboration workspace at the time of the interaction.

39. The product of claim 31, wherein the graphical representation represents the log of entries for an organization according to the time of the interaction and the classifications of the events.

40. The product of claim 31, wherein the graphical representation represents the log of entries for a team according to the time of the interaction and the classifications of the events.

41. The product of claim 31, wherein the product further includes executable instructions to determine a category score using a weighted combination of classifications of events according to the time of interaction.

42. The product of claim 31, wherein the product further includes executable instructions to determine a collaboration score using a weighted combination of classifications of events according to the time of interaction.

43. The product of claim 31, wherein the product further includes executable instructions to assign weights to the categories using the number of users participating in a collaboration workspace.

44. The product of claim 31, wherein the product further includes executable instructions to receive by a communication link from a client processor controlling an interactive workspace display, messages according to a message protocol identifying events for interactions detected on a part of the workspace being rendered on the interactive workspace display controlled by the client processor, for addition to the log of entries; and
parse the messages according to the message protocol to produce entries for the log of entries.

45. The product of claim 44, wherein the message protocol comprises message formats carrying parameters for an application program interface API, the API including parameters and procedures to render parts of the workspace on workspace displays.
